(19) United States
(12) Patent Application Publication
(10) Pub. No.: US 2025/0232761 A1
(43) Pub. Date: Jul. 17, 2025

(54) TRAINING SYSTEM AND METHOD FOR ACOUSTIC MODEL

(71) Applicant: Yamaha Corporation, Hamamatsu (JP)

(72) Inventors: Ryunosuke DAIDO, Hamamatsu (JP); Keijiro SAINO, Hamamatsu (JP); Masanari NISHIMURA, Hamamatsu (JP); Masahiro SHIMIZU, Hamamatsu (JP)

(21) Appl. No.: 19/169,659

(22) Filed: Apr. 3, 2025

Related U.S. Application Data
(63) Continuation of application No. PCT/JP2023/035432, filed on Sep. 28, 2023.
(60) Provisional application No. 63/412,887, filed on Oct. 4, 2022.

(30) Foreign Application Priority Data
Dec. 1, 2022 (JP) 2022-192811
Dec. 28, 2022 (JP) 2022-212414

(51) Int. Cl. G10L 13/06; G06F 3/16

(52) U.S. Cl. CPC G10L 13/06; G06F 3/167

(57) ABSTRACT

An acoustic model training system includes a first device that is connectable to a network and that is used by a first user, and a server that is connectable to the network. The first device, under control by the first user, is configured to upload a plurality of sound waveforms to the server, select, as a first waveform set, one or more sound waveforms from the plurality of sound waveforms after or before updating the plurality of sound waveforms, and transmit to the server a first execution instruction for a first training job for an acoustic model configured to generate acoustic features. The server is configured to, based on the first execution instruction from the first device, start execution of the first training job using the first waveform set, and provide, to the first device, a trained acoustic model trained by the first training job.

### CROSS-REFERENCE TO RELATED APPLICATIONS

This application is a continuation application of International Application No. PCT/JP2023/035432, filed on Sep. 28, 2023, which claims priority to U.S. Provisional Patent Application No. 62/412,887, filed on Oct. 4, 2022, Japanese Patent Application No. 2022-192811 filed in Japan on Dec. 1, 2022, and Japanese Patent Application No. 2022-212414 filed in Japan on Dec. 28, 2022. The entire disclosures of U.S. Provisional Patent Application No. 62/412,887 and Japanese Patent Application Nos. 2022-192811 and 2022-212414 are hereby incorporated herein by reference.

### BACKGROUND

### Technical Field

This disclosure generally relates to a training system and method for an acoustic model.

### Background Information

Sound synthesis technology for synthesizing voice of specific singers and performance sounds of specific musical instruments is known. In particular, in sound synthesis technology using machine learning (for example, Japanese Laid Open Patent Application No. 2020-076843 and International Publication No. 2022/080395), a sufficiently trained acoustic model is required in order to output synthesized sounds with natural pronunciation for the specific voice and performance sounds, based on musical score data and audio data input by a user.

### SUMMARY

However, in order to sufficiently train an acoustic model, it is necessary to label linguistic features for a vast amount of voice and performance sounds, which requires an immense amount of time and cost to perform said training. As a result, only companies having sufficient funds can train acoustic models, limiting the types of acoustic models.

In addition, there are cases in which noise or unnecessary sounds are included in the sound source used for training when training an acoustic model, causing problems such as reduction in training quality.

One object of one embodiment of this disclosure is to make it possible to select data to be used for training an acoustic model from a plurality of pieces of training data, thereby making it possible to easily execute various types of training.

One object of one embodiment of this disclosure is to use in the training, from among sound waveforms used for training, only a portion(s) desired by a user, thereby efficiently training an acoustic model.

A training system for an acoustic model according to one embodiment of this disclosure comprises a first device that is connectable to a network and that is used by a first user, and a server that is connectable to the network. The first device, under control by the first user, is configured to upload a plurality of sound waveforms to the server, select, as a first waveform set, one or more sound waveforms from the plurality of sound waveforms after or before updating the plurality of sound waveforms, and transmit to the server a first execution instruction for a first training job for an acoustic model configured to generate acoustic features. The server is configured to, based on the first execution instruction from the first device, start execution of the first training job using the first waveform set, and provide, to the first device, a trained acoustic model trained by the first training job.

A training method for an acoustic model according to one embodiment of this disclosures is realized by one or more computers and comprises providing, to a first user, an interface for selecting, from a plurality of pre-stored sound waveforms, one or more sound waveforms to be used in a first training job for an acoustic model configured to generate acoustic features.

A training method for an acoustic model according to one embodiment of this disclosure is a training method for an acoustic model that generates acoustic features for synthesizing a synthetic sound waveform in accordance with input of features of a musical piece, realized by one or more computers. The method comprises detecting, from all sections of a sound waveform selected for training, a plurality of specific sections each of which includes timbre of the sound waveform in a specific range along a time axis, and training the acoustic model, using the sound waveform for the plurality of specific sections that have been detected.

### BRIEF DESCRIPTION OF THE DRAWINGS

FIG. 1 is a diagram showing an overall configuration of an acoustic model training system according to one embodiment of this disclosure.

FIG. 2 is a block diagram showing a configuration of a server according to one embodiment of this disclosure.

FIG. 3 is a block diagram showing the concept of an acoustic model according to one embodiment of this disclosure.

FIG. 4 is a sequence diagram showing an acoustic model training method and a sound synthesis method according to one embodiment of this disclosure.

FIG. 5 is a diagram showing one example of a GUI in the acoustic model training method according to one embodiment of this disclosure.

FIG. 6 is a sequence diagram showing an acoustic model training method and a sound synthesis method according to one embodiment of this disclosure.

FIG. 7 is a diagram showing one example of a GUI related to information disclosure and trial listening request for an acoustic model according to one embodiment of this disclosure.

FIG. 8 is a sequence diagram showing an acoustic model training method and a sound synthesis method according to one embodiment of this disclosure.

FIG. 9 is a diagram showing one example of a GUI when setting disclosure information when training an acoustic model according to one embodiment of this disclosure.

FIG. 10 is a flowchart showing an acoustic model training method according to one embodiment of this disclosure.

FIG. 11 is a sequence diagram showing a method for recording a sound waveform used for training an acoustic model according to one embodiment of this disclosure.

FIG. 12 is a diagram showing a structure of data managed by a server according to one embodiment of this disclosure.

FIG. 13 is a diagram showing data transmitted to a server in training an acoustic model according to one embodiment of this disclosure.

FIG. 14 is a flowchart showing an acoustic model training method according to one embodiment of this disclosure.

FIG. 15 is a flowchart showing a method for recommending a musical piece suitable for training an acoustic model according to one embodiment of this disclosure.

FIG. 16 is an overall configuration diagram of an acoustic model training system.

FIG. 17 is a configuration diagram of a server.

FIG. 18 is an explanatory diagram of an acoustic model.

FIG. 19 is a sequence diagram illustrating an acoustic model training method.

FIG. 20 is a flowchart illustrating an acoustic model training method.

FIG. 21 is a diagram showing one example of a graphical user interface (GUI) for selecting a sound waveform used for training an acoustic model.

FIG. 22 is a diagram showing one example of a GUI for editing a specific section of a sound waveform used for training an acoustic model.

FIG. 23 is a diagram showing an example of editing in which a boundary of a specific section is moved.

FIG. 24 is a diagram showing an example of editing in which a boundary of a specific section is deleted and added.

FIG. 25 is a flowchart showing a process executed in step S502.

FIG. 26 is a diagram explaining a project overview of a service according to one embodiment of this disclosure.

FIG. 27 is a diagram providing background information of the service according to one embodiment of this disclosure.

FIG. 28 is a diagram explaining an overview of functions of the service according to one embodiment of this disclosure.

FIG. 29 is a diagram explaining an overview of functions of the service according to one embodiment of this disclosure.

FIG. 30 is a diagram explaining an overview of functions of the service according to one embodiment of this disclosure.

FIG. 31 is a diagram explaining implementation of the service according to one embodiment of this disclosure.

FIG. 32 is a diagram explaining a system configuration of the service according to one embodiment of this disclosure.

FIG. 33 is a diagram explaining future plans as a commercial service regarding the service according to one embodiment of this disclosure.

FIG. 34 is a diagram showing a conceptual image of a structure of the service according to one embodiment of this disclosure.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

A system and a method for training an acoustic model according to one embodiment of this disclosure will be described in detail below, with reference to the drawings. The following embodiments are merely examples of embodiments for implementing this disclosure, and this disclosure is not to be construed as being limited to these embodiments. In the drawings being referenced in the present embodiment, parts that are the same or that have similar functions are assigned the same or similar symbols (symbols in which A, B, etc., are simply added after numbers), and redundant explanations can be omitted.

In the following embodiments, “musical score data” are data including information relating to the pitch and intensity of notes, information relating to the phonemes of notes, information relating to the pronunciation periods of notes, and information relating to performance symbols. For example, musical score data are data representing the musical score and/or lyrics of a musical piece. The musical score data can be data representing a time series of notes constituting the musical piece, or can be data representing the time series of language constituting the musical piece.

“Sound waveform” refers to waveform data of sound. A sound source that emits the sound is identified by a sound source ID (identification). For example, a sound waveform is waveform data of singing and/or waveform data of musical instrument sounds. For example, the sound waveform includes waveform data of a singer's voice and performance sounds of a musical instrument captured via an input device, such as a microphone. The sound source ID identifies the timbre of the singer's singing or the timbre of the performance sounds of the musical instrument. Of the sound waveforms, a sound waveform that is input in order to generate synthetic sound waveforms using an acoustic model is referred to as “sound waveform for synthesis,” and a sound waveform used for training an acoustic model is referred to as “sound waveform for training.” When there is no need to distinguish between a sound waveform for synthesis and a sound waveform for training, the two are collectively referred to simply as “sound waveform.”

An “acoustic model” has an input of musical score features of musical score data and an input of acoustic features of sound waveforms. As an example, an acoustic model that is disclosed in International Publication No. 2022/080395 and that has a musical score encoder 111, an acoustic encoder 121, a switching unit 131, and an acoustic decoder 133 is used as the acoustic model. This acoustic model is a sound synthesis model obtained by processing the musical score features of the musical score data that have been input, or by processing the acoustic features of a sound waveform and a sound source ID. The acoustic model is a sound synthesis model used by a sound synthesis program. The sound synthesis program has a function for generating acoustic features of a target sound waveform having the timbre indicated by the sound source ID, and is a program for generating a new synthetic sound waveform. The sound synthesis program supplies, to an acoustic model, the sound source ID and the musical score features generated from the musical score data of a particular musical piece, to obtain the acoustic features of the musical piece in the timbre indicated by the sound source ID, and converts the acoustic features into a sound waveform. Alternatively, the sound synthesis program supplies, to an acoustic model, the sound source ID and the acoustic features generated from the sound waveform of a particular musical piece, to obtain new acoustic features of the musical piece in the timbre indicated by the sound source ID, and converts the new acoustic features into a sound waveform. A prescribed number of sound source IDs are prepared for each acoustic model. That is, each acoustic model selectively generates acoustic features of the timbre indicated by the sound source ID, from among a prescribed number of timbres.

An acoustic model is a generative model of a prescribed architecture that uses machine learning, such as a convolutional neural network (CNN) or a recurrent neural network (RNN). Acoustic features represent the features of sound generation in the frequency spectrum of the waveform of a natural sound or a synthetic sound. Acoustic features being similar means that the timbre, or the temporal change thereof, in a singing voice or in performance sounds is similar.

When training an acoustic model, variables of the acoustic model are changed such that the acoustic model generates acoustic features that are similar to the acoustic features of the referenced sound waveform. For example, the training program P2, the musical score data D1 (musical score data for training), and the audio data for learning D2 (sound waveform for training) disclosed in International Publication No. 2022/080395 are used for training. Through basic training using waveforms of a plurality of sounds corresponding to a plurality of sound source IDs, variables of the acoustic model (musical score encoder, acoustic encoder, and acoustic decoder) are changed so that it is possible to generate acoustic features of synthetic sounds with a plurality of timbres corresponding to the plurality of sound source IDs. Furthermore, by subjecting the trained acoustic model to supplementary training using a sound waveform of a different timbre corresponding to a new sound (unused) source ID, it becomes possible for the acoustic model to generate acoustic features of the timbre indicated by the new sound source ID. Specifically, by further subjecting a trained acoustic model trained using sound waveforms of the voices of XXX (multiple people) to supplementary training using a sound waveform of the voice of YYY (one person) using a new sound source ID, variables of the acoustic model (at least the acoustic decoder) are changed so that the acoustic model can generate the acoustic features of YYY's voice. A unit of training for an acoustic model corresponding to a new sound source ID, such as that described above, is referred to as a “training job.” That is, a training job means a sequence of training processes that is executed by a training program.

A “program” refers to a command or a group of commands executed by a processor in a computer provided with the processor and a memory unit. A “computer” is a collective term referring to a means for executing programs. For example, when a program is executed by a server (or a client), the “computer” refers to the server (or client). When a “program” is executed by distributed processing between a server and a client, the “computer” includes both the server and the client. In this case, the “program” includes a “program executed by a server” and a “program executed by a client.” Similarly, when a “program” is executed by distributed processing between a plurality of servers, the “computer” includes the plurality of servers, and the “program” includes each program executed in each server.

The present embodiment is configured as a client-server system, but this disclosure can be implemented in other configurations. For example, the present embodiment can be implemented, as a standalone system, by an electronic device provided with a computer, such as a personal computer (PC), a tablet terminal, a smartphone, an electronic instrument, or an audio device. Alternatively, a plurality of electronic devices connected to a network can implement the present embodiment as a distributed system.

For example, an acoustic model training app can be executed on a PC, and a sound waveform stored locally or in the cloud can be used to train an acoustic model stored locally or in the cloud. In this case, the training job can be executed in the background, utilizing idle time of other tasks.

### 1. First Embodiment

### [1-1. Overall System Configuration]

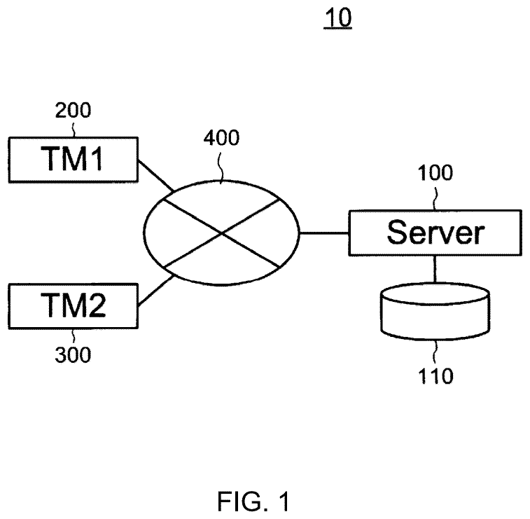

FIG. 1 is a diagram showing an overall configuration of an acoustic model training system according to one embodiment of this disclosure. As shown in FIG. 1, an acoustic model training system 10 comprises a server 100 (server), a communication terminal 200 (TM1), and a communication terminal 300 (TM2). The server 100 and the communication terminals 200, 300 can each connect to a network 400. The communication terminal 200 and the communication terminal 300 can each communicate with the server 100 via the network 400. The communication terminal 200 can be referred to as a “first device.” A user that uses the communication terminal 200 can be referred to as a “first user.”

In the present embodiment, the server 100 is a computer that functions as a sound synthesizer and carries out training of acoustic models. The server 100 is provided with storage 110. FIG. 1 illustrates a configuration in which the storage 110 is directly connected to the server 100, but the invention is not limited to this configuration. For example, the storage 110 can be connected to the network 400 directly or via another computer, and data can be received and transmitted between the server 100 and the storage 110 via the network 400.

The communication terminal 200 is a terminal for selecting a training sound waveform for training an acoustic model and sending an instruction to the server 100 to execute the training. The communication terminal 300 is a terminal that is different from the communication terminal 200 and that can access the server 100. While the details will be described below, the communication terminal 300 is a terminal for viewing or trial listening to disclosed information relating to an acoustic model under training. The communication terminals 200, 300 include mobile communication terminals, such as smartphones or tablet terminals, and stationary communication terminals such as desktop computers.

The network 400 can be the Internet provided by a common World Wide Web (WWW) service, a Wide Area Network (WAN), or a Local Area Network (LAN), such as a corporate LAN.

### [1-2. Configuration of a Server Used for Sound Synthesis]

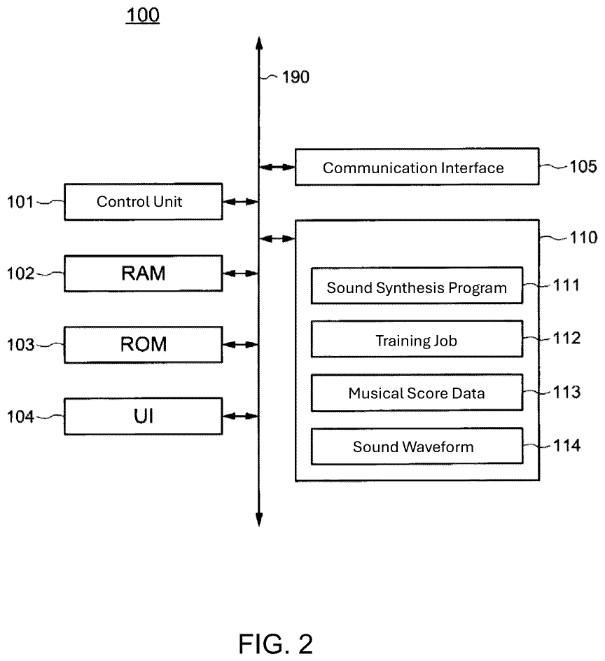

FIG. 2 is a block diagram showing a configuration of a server according to one embodiment of this disclosure. As shown in FIG. 2, the server 100 comprises a control unit (electronic controller) 101, random access memory (RAM) 102, read only memory (ROM) 103, a user interface (UI) 104, a communication interface 105, and the storage 110. The sound synthesis technology of the present embodiment is realized by cooperation between each of the functional units of the server 100.

The control unit 101 includes at least one or more processors such as a central processing unit (CPU) or a graphics processing unit (GPU), and at least one or more storage devices such as registers and memory connected to said CPU and GPU. The control unit 101 executes, with the CPU and the GPU, programs temporarily stored in the memory, to realize each of the functions provided in the server 100. Specifically, the control unit 101 performs computational processing in accordance with various types of request signals from the communication terminal 200 and provides content data to the communication terminals 200 and 300.

The RAM 102 temporarily stores content data, acoustic models (composed of an architecture and variables), control programs necessary for the computational processing, and the like. The RAM 102 is used, for example, as a data buffer, and temporarily stores various data received from an external device, such as the communication terminal 200, until the data are stored in the storage 110. General-purpose memory, such as static random access memory (SRAM) or dynamic random access memory (DRAM), can be used as the RAM 102.

The ROM 103 stores various programs, various acoustic models, parameters, etc., for realizing the functions of the server 100. The programs, acoustic models, parameters, etc., stored in the ROM 103 are read and executed or used by the control unit 101 as needed.

The user interface 104, by the control of the control unit 101, displays various display images, such as a graphical user interface (GUI), on a display unit thereof, and receives input from a user of the server 100. The display unit is a display, for example, a liquid-crystal display (LCD), or a light-emitting diode (LED) display, or a touch panel.

The communication interface 105 is an interface for connecting to the network 400 and sending and receiving information with other communication devices such as the communication terminals 200, 300 connected to the network 400, by the control of the control unit 101.

The storage 110 is a recording device (storage medium) capable of permanent information storage and rewriting, such as nonvolatile memory or a hard disk drive. The storage 110 stores information such as programs, acoustic models, and parameters, etc., required to execute said programs. As shown in FIG. 2, the storage 110 stores a sound synthesis program 111, a training job 112, musical score data 113, and a sound waveform 114. Programs and data related to common sound synthesis can be used as the above-mentioned programs and data, such as the sound synthesis program P1, the training program P2, the musical score data D1, and the audio data D2 disclosed in International Publication no. 2022/080395.

As described above, the sound synthesis program 111 is a program for generating synthetic sound waveforms from musical score data or sound waveforms. When the control unit 101 executes the sound synthesis program 111, the control unit 101 uses an acoustic model 120 to generate a synthetic sound waveform. The synthetic sound waveform corresponds to the audio data D3 disclosed in International Publication no. 2022/080395. The training program for the acoustic model 120 executed by the control unit 101 in the training job 112 is, for example, the program for training an encoder and an acoustic decoder disclosed in International Publication no. 2022/080395. The musical score data are data that define a musical piece. The sound waveform is waveform data of a voice or a performance sound, such as waveform data representing a singer's singing voice or a performance sound of a musical instrument.

### [1-3. Functional Configuration of a Server Used for Sound Synthesis]

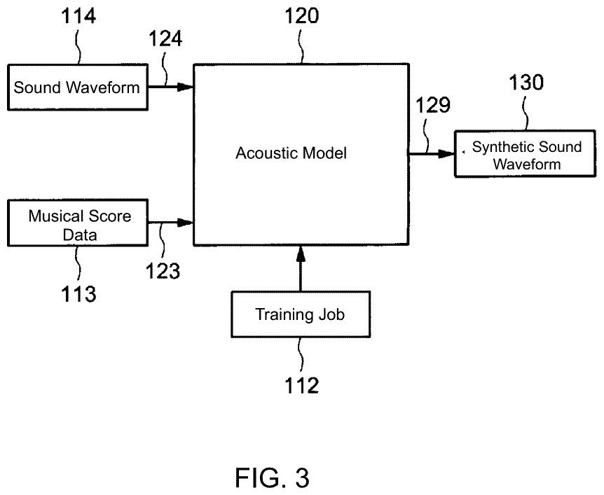

FIG. 3 is a block diagram showing the concept of an acoustic model according to one embodiment of this disclosure. As described above, the acoustic model 120 is a machine learning model used in sound synthesis technology executed by the control unit 101 of FIG. 2, when the control unit 101 reads and executes the sound synthesis program 111. The acoustic model 120 generates acoustic features. Musical score features 123 of the musical score data 113 or acoustic features 124 of the sound waveform 114 of a desired musical piece are input to the acoustic model 120 as an input signal by the control unit 101. The sound source ID and the musical score features 123 are processed using the acoustic model 120, thereby generating acoustic features 129 of the synthesized sound of the musical piece. Based on the acoustic features 129, the control unit 101 synthesizes the musical piece with the synthetic sound waveform 130 sung by the singer or played by a musical instrument specified by the sound source ID, and outputs the synthesized result. Alternatively, the sound source ID and the acoustic features 124 are processed using the acoustic model 120, thereby generating acoustic features 129 of the synthesized sound of the musical piece. Based on the acoustic features 129, the control unit 101 synthesizes and outputs the synthetic sound waveform 130, in which the sound waveform of the musical piece is converted to the timbre of the singing of the singer or the performance sound of the musical instrument specified by the sound source ID.

The acoustic model 120 is a generative model that uses machine learning. The acoustic model 120 is trained by the control unit 101 executing a training program (i.e., executing the training job 112). The control unit 101 uses (an unused) new sound source ID and a sound waveform for training to train the acoustic model 120 and determines the variables of the acoustic model 120 (at least the acoustic decoder). Specifically, the control unit 101 generates acoustic features for training from the sound waveform for training, and when a new sound source ID and acoustic features for training are input to the acoustic model 120, the control unit 101 gradually and repeatedly changes the variables described above such that the acoustic features for generating the synthetic sound waveform 130 approach the acoustic features for training. The sound waveform for training can be uploaded (transmitted) to the server 100 from the communication terminal 200 or the communication terminal 300 and stored in the storage 110 as user data, or can be stored in the storage 110 in advance by an administrator of the server 100 as reference data. In the following description, storing in the storage 110 can be referred to as storing in the server 100.

### [1-4. Sound Synthesis Method]

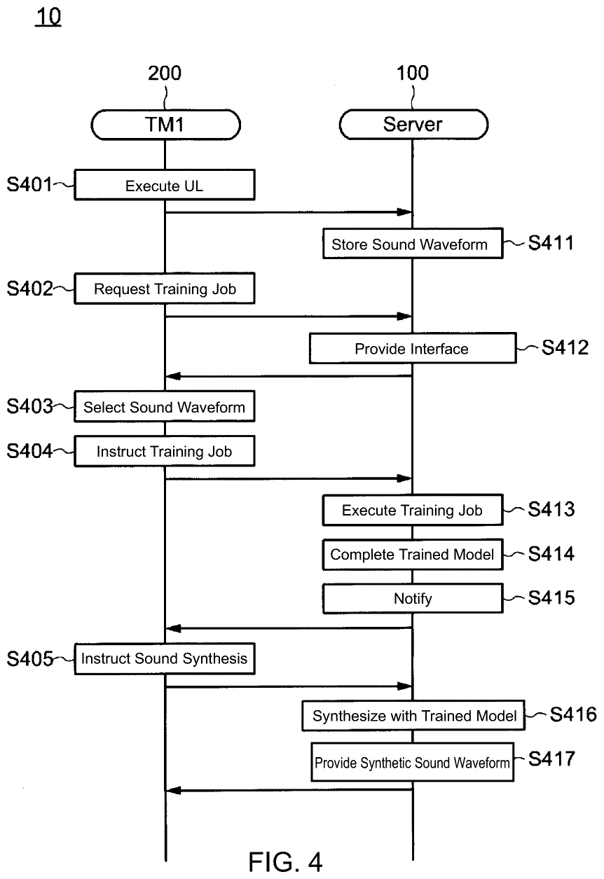

FIG. 4 is a sequence diagram showing an acoustic model training method and a sound synthesis method according to one embodiment of this disclosure. In the acoustic model training method shown in FIG. 4, an example is shown in which the communication terminal 200 uploads a sound waveform for training to the server 100. However, as described above, the sound waveform for training can be pre-stored in the server 100 by other means. The training job in the sequence shown in FIG. 4 can be referred to as the “first training job.” Each step of the process TM1 on the communication terminal 200 side and each step of the process on the server 100 side are actually executed by a control unit (electronic controller including at least one or more processors) of the communication terminal 200 and the control unit 101 of the server 100. However, for simplicity of explanation, the communication terminal 200 and the server 100 are represented as executing each of the steps. Unless otherwise specified, the same applies to the explanations of the subsequent sequence diagrams and flowcharts.

As shown in FIG. 4, first, the communication terminal 200 (first device) uploads (transmits) one or more sound waveforms for training to the server 100, based on an instruction from a first user that has logged in to the first user's account on the server 100 (step S401). The server 100 stores the sound waveform for training transmitted in S401 to the first user's storage area (step S411). One or more sound waveforms can be uploaded to the server 100. The plurality of sound waveforms can be separately stored in a plurality of folders in the first user's storage area. Steps S401, 411 described above are steps relating to preparation for executing the following training job.

Steps for executing a training job will be described next. The communication terminal 200 requests the server 100 to execute a training job (step S402). In response to the request made in S402, the server 100 provides the communication terminal 200 with a graphical user interface (GUI) for selecting, from among pre-stored sound waveforms (and sound waveforms that are planned to be stored (will be stored)), sound waveforms to be used for the training job.

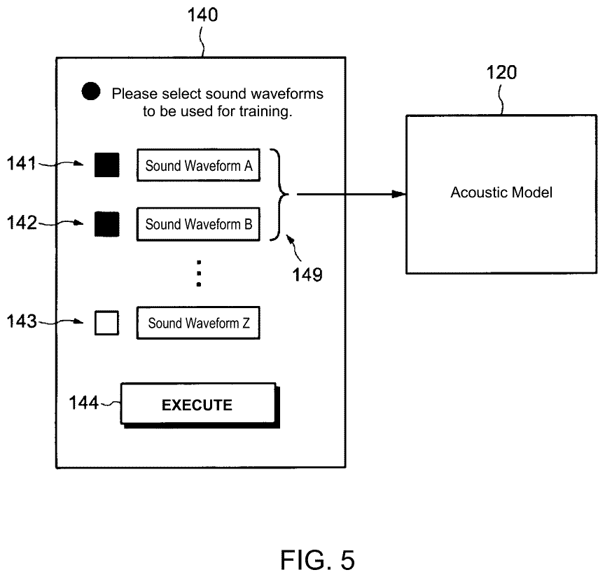

The communication terminal 200 displays, on a display unit thereof, the GUI provided in S412. The display unit of the communication terminal 20 is a display, for example, a liquid-crystal display (LCD), or a light-emitting diode (LED) display, or a touch panel. The first user uses the GUI to select, as a waveform set 149 (refer to FIG. 5), one or more sound waveforms for training from among the plurality of sound waveforms uploaded in the storage area (or a desired folder) (step S403). After the waveform set 149 (sound waveform for training) is selected in S403, the communication terminal 200 instructs the start of execution of the training job in response to an instruction from the first user (step S404).

Based on the instruction from the communication terminal 200 (first device) in S404, the server 100 starts the execution of the training job using the selected waveform set 149 (step S413). In other words, in S413, the training job is executed based on the first user's instruction provided via the GUI in S412.

Not all of the waveforms in the selected waveform set 149 are used for training; rather, a preprocessed waveform set that includes only useful sections and excludes silent sections and noise sections is used. The acoustic model 120 in which the acoustic decoder is untrained can be used as the acoustic model 120 (base acoustic model) to be trained. However, by selecting and using, as the acoustic model 120 to be trained, the acoustic model 120 containing an acoustic decoder that has learned to generate acoustic features that are similar to the acoustic features of waveforms in the waveform set 149, from among of the plurality of acoustic models 120 already subjected to basic training, it is possible to reduce the time and cost required for the training job. Regardless of which acoustic model 120 is selected, a musical score encoder and an acoustic encoder that have been subjected to basic training are used.

The base acoustic model can be determined by the server 100 based on the waveform set 149 selected by the first user. Alternatively, the first user can select, as the base acoustic model, one of a plurality of trained acoustic models. The first execution instruction can include designation data indicating the base acoustic model. An unused new sound source ID is used as the sound source ID (for example, singer ID, instrument ID, etc.) supplied to the acoustic decoder. Here, the user does not necessarily need to know which sound source ID has been used as the new sound source ID. However, when performing sound synthesis using a trained model, the new sound source ID is automatically used.

In the training job, unit training is repeated, in which partial short waveforms are extracted little by little from a preprocessed waveform set, and the extracted short waveform is used to train the acoustic model (at least the acoustic decoder). In the unit training, the new sound source ID and the acoustic features of the short waveform are input to the acoustic model 120, and the variables of the acoustic model are adjusted accordingly so as to reduce the difference between the acoustic features output by the acoustic model 120 and the acoustic features that have been input. For example, backpropagation method is used for the adjustment of the variables. Once training using a preprocessed waveform set is completed by repeating unit training, the quality of the acoustic features generated by the acoustic model 120 is evaluated, and if the quality does not meet a prescribed standard, the preprocessed waveform set is used to train the acoustic model again. If the quality of the acoustic features generated by the acoustic model 120 meets the prescribed standard, the training job is completed, and the acoustic model 120 at that time point becomes the trained acoustic model 120.

When the training job is completed in S413, the trained acoustic model 120 is established (step S414). This trained acoustic model 120 can be referred to as the “first acoustic model.” The server 100 notifies the communication terminal 200 that the trained acoustic model 120 has been established (step S415). The steps S403 to S415 described above are the training job for the acoustic model 120.

After the notification of S415, the communication terminal 200 transmits, to the server 100, an instruction for sound synthesis, including the musical score data of the desired musical piece, in accordance with an instruction from the first user (step S405). In response, the server 100 executes a sound synthesis program, and executes sound synthesis using the trained acoustic model 120 completed in S414 based on the musical score data (step S416). The synthetic sound waveform 130 generated in S416 is transmitted to the communication terminal 200 (step S417). The new sound source ID is used in this sound synthesis.

It can be said that, S416 in combination with S417 provides the trained acoustic model 120 (sound synthesis function) trained by the training job to the communication terminal 200 (first device) or the first user. The execution of the sound synthesis program of step S416 can be carried out by the communication terminal 200 instead of the server 100. In that case, the server 100 transmits the trained acoustic model 120 to the communication terminal 200. The communication terminal 200 uses the trained acoustic model 120 that has been received to execute a sound synthesis process based on the musical score data of the desired musical piece with the new sound source ID, to obtain the synthetic sound waveform 130.

In the present embodiment, before execution of the training job is requested in S402, the sound waveform for training is uploaded in S401, but the invention is not limited to this configuration. For example, the upload of the sound waveform for training can be carried out after execution of the training job is instructed in S404. In this case, in S403, one or more sound waveforms can be selected, as the waveform set 149, from a plurality of sound waveforms (including sound waveforms that have not been uploaded) stored in the communication terminal 200, and, of the selected sound waveforms, sound waveforms that have not been uploaded can be uploaded in accordance with an instruction to execute a training job.

### [1-5. GUI 140]

Here, one example of the GUI provided in S412 will be described. FIG. 5 is a diagram showing one example of the GUI in the acoustic model training method according to one embodiment of this disclosure. The GUI 140 shown in FIG. 5 is displayed on a display unit included in the user interface of the communication interface 200. As shown in FIG. 5, the GUI 140 displays a sound waveform A, a sound waveform B, . . . , a sound waveform Z (for example, sound waveforms uploaded in a specific folder) as candidates for the sound waveform for training. Check boxes 141, 142, . . . , 143 are displayed next to each sound waveform. The sound waveforms A, B, . . . , Z displayed as candidates for the sound waveform for training are, for example, sound waveforms relating to the singing voice of the same person, and each can be a different song or have a different singing style. The sound waveforms can be various performance sounds of the same musical instrument.

In other words, in S412, the server 100 provides, to the communication terminal 200, a GUI that allows the first user to select, as the waveform set 149, one or more sound waveforms for executing the training job for the acoustic model 120, from among the plurality of pre-stored sound waveforms (and sound waveforms that are planned to be stored).

In S403 described above, the sound waveform for training is selected as a result of the first user of the communication terminal 200 checking the check boxes 141, 142, . . . , 143 shown in FIG. 5. FIG. 5 shows an example in which the check boxes 141 and 142 are checked as the sound waveforms for training, thereby selecting the sound waveforms A and B as the waveform set 149. One or more waveforms can be selected as the waveform set 149.

In S404 described above, in response to an execute button 144 being pressed with the check boxes 141 and 142 selected, the communication terminal 200 executes the instruction for the training job of S404. In response to the training job instruction, the server 100 starts the training for the acoustic model 120 using the waveform set 149 consisting of the sound waveforms A and B. The execute button 144 being pressed includes the execute button 144 being clicked or tapped.

As described above, the acoustic model training system 10 according to the present embodiment selects one or more sound waveforms from a plurality of sound waveforms pre-stored (and sound waveforms that are planned to be stored) in the storage 110, and executes a training job for the acoustic model 120 using the selected sound waveform as the sound waveform for training. With the configuration described above, the first user of the communication terminal 200 trains the untrained acoustic model 120 or the trained acoustic model 120 to obtain the desired acoustic model 120. The sound waveform can be uploaded to the server 100 after the selection of the waveform set 149 or after the instruction to execute the training job. That is, the sound waveform to be used for the training job can be uploaded from the communication terminal 200 to the server 100 at any point in time before the training job is started. With supplementary training of an acoustic model in which the acoustic decoder is already trained, the trained acoustic model 120 can be obtained in a shorter time and at a lower cost, compared to the conventional acoustic model 120.

### 2. Second Embodiment

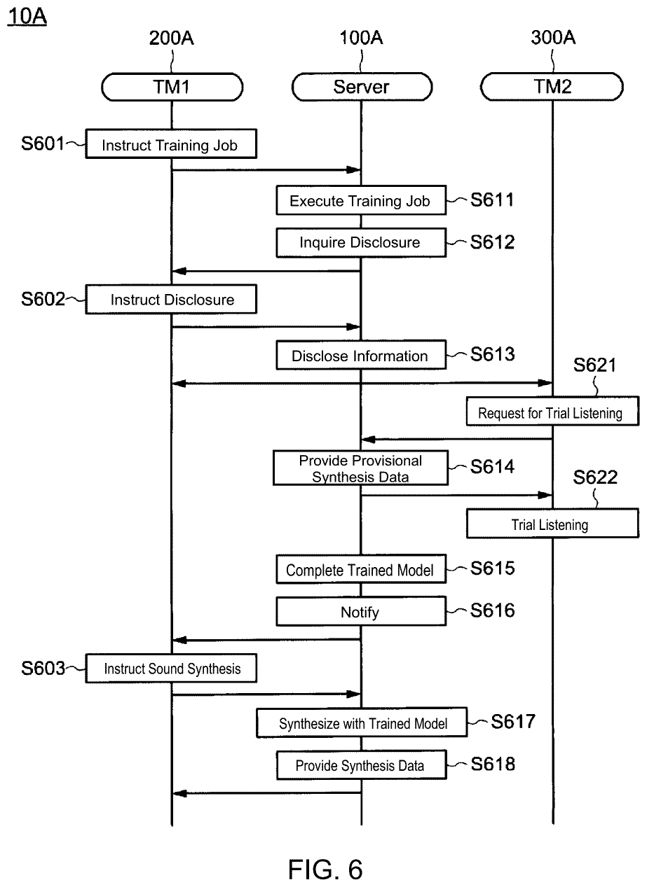

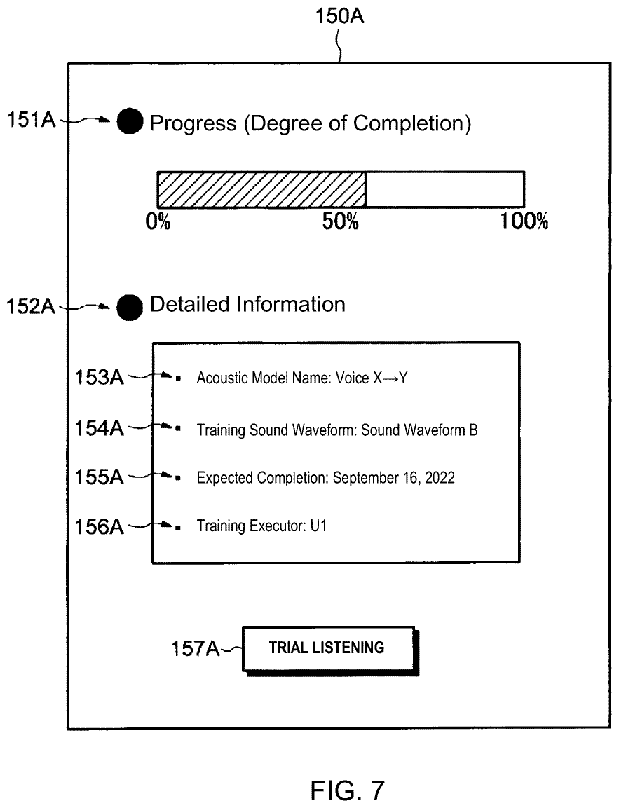

An acoustic model training system 10A according to a second embodiment will be described with reference to FIGS. 6 and 7. The overall configuration of the acoustic model training system 10A and the block diagram relating to the server are the same as those for the acoustic model training system 10 according to the first embodiment, so the explanations thereof are omitted. In the following description, explanations of configurations that are the same as the first embodiment are omitted, and differences from the first embodiment will be mainly explained. In the following description, when describing configurations that are similar to those of the first embodiment, FIGS. 1 to 5 will be referenced, and the alphabet “A” will be added after the reference symbols indicated in these figures.

### [2-1. Sound Synthesis Method]

FIG. 6 is a sequence diagram showing an acoustic model training method and a sound synthesis method according to one embodiment of this disclosure. In the acoustic model training method shown in FIG. 6, a configuration will be described in which information indicating the progress of a training job is disclosed to a third party, from the time the training job is started at a user's instruction to the time when the trained acoustic model is completed. Steps before step S601 in FIG. 6 are the same as S401 to S403 in FIG. 4, and thus the descriptions thereof are omitted. S601 in FIG. 6 is the same as S404 in FIG. 4. In the following description, a user that uses a communication terminal 300A and that corresponds to the third party described above can be referred to as the “second user.”

A server 100A starts the execution of a training job for a base acoustic model using a new sound source ID and a selected waveform set 149A, based on an execution instruction from a first user via a communication terminal 200A in S601 (step S611). When the training job is completed, a trained acoustic model 120A trained by this waveform set 149A is obtained as a result. When the training job is started in S611, the server 100A notifies the communication terminal 200A that the training job has been started, and inquires the communication terminal 200A whether status information indicating the training job status can be disclosed to a third party, that is, whether the third party is allowed to view the status information (step S612). If the first user issues, in response to the inquiry in S612, a disclosure instruction to disclose the status information indicating the training job status, the communication terminal 200A transmits the disclosure instruction to the server 100A (step S602). If the first user does not issue a disclosure instruction, the communication terminal 200A does not transmit a disclosure instruction. This status information is transmitted to the communication terminal 200A regardless of the presence/absence of the disclosure instruction, and is displayed on the display unit thereof and viewed by the first user.

The server 100A discloses, to the communication terminal 300A, status information indicating the status of the training job of the first user which was started in S611, based on a disclosure instruction from the first user in S602, as described above (step S613). As a result, a third party is able to view the status information displayed on the display unit of the communication terminal 300A.

If the first user has agreed in advance to disclose the status information indicating the training job status, and a disclosure instruction is issued based thereon, steps S612 and S602 can be omitted. That is, status information indicating the status of the training job of the first user can be disclosed to a second user based on the disclosure instruction given in advance by the first user.

The steps S615 to S618 after S622 are similar to S414 to S417 in FIG. 4, and thus the descriptions thereof are omitted.

In FIG. 6, an example is shown in which the communication terminal 300A, which is different from the communication terminal 200A that issues an instruction to execute the training job, is the means of executing a trial listening request, but the invention is not limited to this configuration. For example, the communication terminal 200A (first user) that instructed the execution of the training job can itself execute a trial listening request in order to check the progress of the training job. For example, if the communication terminal 200A makes a trial listening request, the training job can be ended at a timing at which the first user is satisfied with the synthetic sound waveform for trial listening, even if the progress has not reached 100%.

### [2-2. GUI 150A]

Here, one example of the GUI provided in S613 will be described. FIG. 7 is a diagram showing one example of a GUI related to information disclosure and trial listening request of an acoustic model according to one embodiment of this disclosure. A GUI 150A shown in FIG. 7 is displayed on the display units of the communication terminals 200A and 300A.

As shown in FIG. 7, an item 151A indicating the progress corresponding to the status information, an item 152A indicating detailed information, and a trial listening button 157A for requesting a trial listening, are displayed in the GUI 150A. In the present embodiment, the item 151A indicating progress indicates the progress of the training job for an acoustic model 120A. However, said item 151A can be an item other than the degree of completion, such as the elapsed time in which the predicted completion is 100%, the degree of change in a variable of the acoustic model 120A, and the like.

The item 151A is a progress bar that displays the progress of the training job as a percentage. In the item 151A, the current status indicated by the progress is the current amount of training relative to the total amount of training. The total amount of training can be the amount of training estimated at the start of the training job, or the amount of training estimated based on the state of change of a variable of the acoustic model 120A during execution of the training job. That is, the training job status changes over time, and the server 100A provides the progress indicating the temporal change of the training job status to be displayed on the communication terminal as the item 151A. Since the training job status changes over time, the server 100A updates the status information indicating the training job status periodically or when the information changes, and repeatedly provides the status information to the communication terminals 200A and 300A.

In the present embodiment, an example is shown in which the status information indicating the training job status is repeatedly provided to the communication terminals 200A and 300A in real time, but the invention is not limited to this configuration. For example, a configuration can be used in which the status information can be provided only once to each of the communication terminals 200A and 300A. Alternatively, a configuration can be used in which the status information described above is displayed on the communication terminal 300A (second device) at the timing of a disclosure request, based on the disclosure request made by a second user using the communication terminal 300A.

In FIG. 7, a configuration in which a progress bar is displayed as the item 151A indicating progress is illustrated as an example, but the invention is not limited to this configuration. For example, the progress can be displayed numerically as a percentage.

The item 152A is information indicating the details of the training job. In FIG. 7, an acoustic model name 153A, a training sound waveform 154A, expected completion 155A, and training executor 156A are displayed as examples of the detailed information of the item 152A. The acoustic model name 153A is a name set by the first user. For example, “voice X-+Y” means transforming the pre-training acoustic model 120A (base acoustic model) for synthesizing the sound of X (one or a plurality of singers X, or one or a plurality of musical instruments X) to the trained acoustic model 120A for synthesizing the sound of Y (a new singer Y or musical instrument Y) with the ongoing training job. The training sound waveform 154A indicates the sound waveform used for training the acoustic model 120A in the ongoing training job. The example of FIG. 7 means that the sound waveform B is used for the acoustic model 120A. The expected completion 155A indicates the date and time at which the progress of the ongoing training job is expected to reach 100%. The training executor 156A indicates the name of the user that executed the ongoing training job. The user name can be an account name or a nickname. In FIG. 7, the training executor 156A is “UI.” UI can be the same as, or different from, the singer or performer related to Y.

The trial listening button 157A is a button for executing a trial listening request, described further below. For example, in FIG. 6, after the information disclosure in S613, when the second user presses the trial listening button 157A, the communication terminal 300A requests a trial listening of the synthesized sound to the server 100A (step S621). When the trial listening request is executed in S621, the server 100A executes sound synthesis for trial listening using the acoustic model 120A of the progress at the time point at which the trial listening request was executed using the new sound source ID and provides the synthetic sound waveform for trial listening (step S614). By providing the synthetic sound waveform for trial listening, the second user that uses the communication terminal 300A can trial listening the synthesized sound generated by the acoustic model 120A at the time point described above (step S622). Naturally, this trial listening can also be carried out on the communication terminal 200A.

The training job is executed collectively in batch units, with a certain group of processes (batch) serving as the unit. If the acoustic model 120A is in the middle of one batch process at the point in time at which the above-mentioned trial listening request is executed, the server 100A can provide a synthetic sound waveform for trial listening generated by the acoustic model 120A obtained in the immediately preceding batch process, or, provide, at a subsequent point in time, a synthetic sound waveform for trial listening generated by the acoustic model 120A obtained at the timing at which the ongoing batch process is completed. That is, based on a trial listening request from the communication terminals 200A and 300A, the server 100A provides, to the first and second users, a synthetic sound waveform for trial listening generated by the acoustic model 120A corresponding to the timing of said trial listening request.

As described above, according to the acoustic model training system 10A of the present embodiment, the second user of the communication terminal 300A can view the process by which the acoustic model 120A is trained and established by the training job. Alternatively, the first user of the communication terminal 200A can end the training job at a satisfactory timing even if the progress has not reached 100%, as described above.

### 3. Third Embodiment

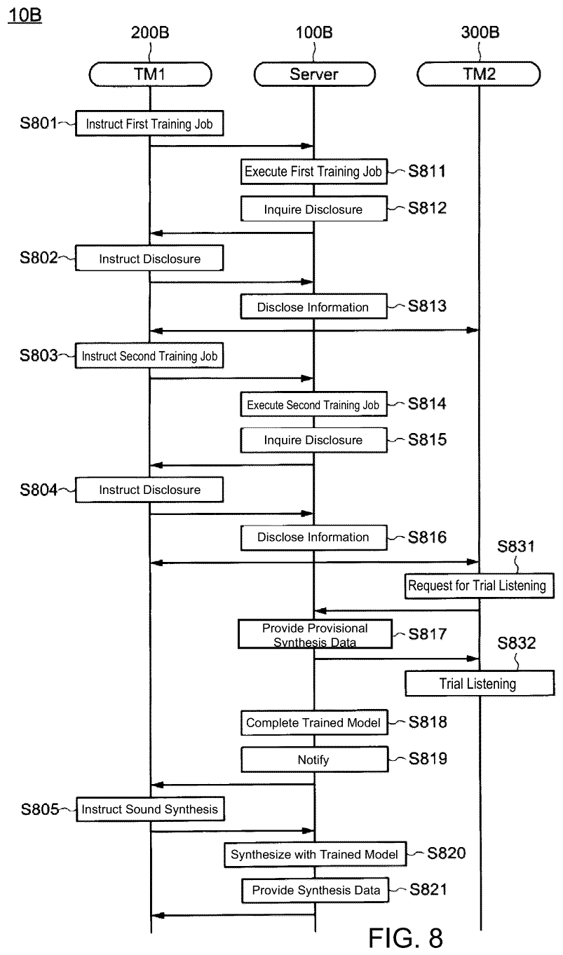

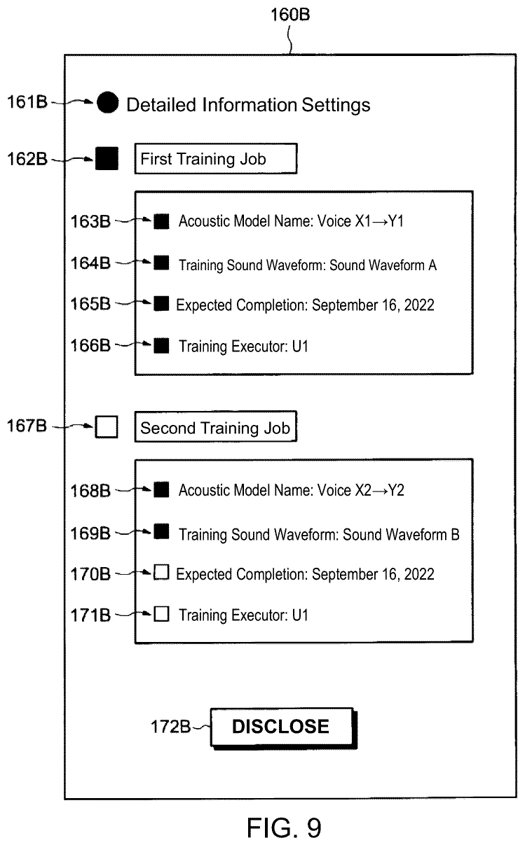

An acoustic model training system 10B according to a third embodiment will be described with reference to FIGS. 8 and 9. The overall configuration of the acoustic model training system 10B and the block diagram relating to the server are the same as those for the acoustic model training system 10 according to the first embodiment, so the explanations thereof are omitted. In the following description, explanations of configurations that are the same as the first embodiment are omitted, and differences from the first embodiment will be mainly explained. In the following description, when describing configurations that are similar to those of the first embodiment, FIGS. 1 to 5 will be referenced, and the alphabet “B” will be added after the reference symbols indicated in these figures.

### [3-1. Sound Synthesis Method]

FIG. 8 is a sequence diagram showing an acoustic model training method and a sound synthesis method according to one embodiment of this disclosure. In the acoustic model training method shown in FIG. 8, a first training job and a second training job are executed in parallel, and the status information relating to each training job is selectively disclosed to a third party. Steps before step S801 in FIG. 8 are the same as S401 to S403 in FIG. 4, and thus the descriptions thereof are omitted. S801 in FIG. 8 is the same as S404 in FIG. 4.

A server 100B executes a first training job for a first base acoustic model using a new sound source ID and a first waveform set selected by the first user, based on a first execution instruction from a communication terminal 200B in S801 (step S811). When the first training job is started in S811, the server 100B notifies the communication terminal 200B that the first training job has been started, and inquires the communication terminal 200B whether first status information relating to the first training job can be disclosed to a third party (step S812). In the present embodiment, the “third party” described above corresponds to the second user. In response to the inquiry of S812, the communication terminal 200B transmits, to the server 100B, a disclosure instruction to disclose the first status information (step S802).

The server 100B discloses, to the communication terminal 300B (second user), the first status information relating to the first training job executed in S811, based on a first disclosure instruction from the first user in S802, as described above (step S813). If the first user does not issue the first disclosure instruction, the server 100B does not disclose the first status information to the second user.

Subsequently, the server 100B executes a second training job for a second base acoustic model using a new sound source ID and a second waveform set selected by the first user, based on a second execution instruction from the communication terminal 200B in S803 (step S814). The first training job and the second training job are executed in parallel with S811 and S814. The first base acoustic model and the second base acoustic model are independent of each other, and the sound source IDs used by the two models are not related. For example, parallel processing of n training jobs is achieved by activating n virtual machines. While the second waveform set used for the second training job is different from the first waveform set used for the first training job, the training program of the second training job is the same as the training program of the first training job. When the first training job is completed, a first trained acoustic model trained by the first waveform set is obtained as a result. When the second training job is completed, a second trained acoustic model trained by the second waveform set is obtained as a result.

The method for executing the second training job is similar to the method for executing the first training job. The second training job uses a second waveform set, which is one or more sound waveforms selected by the first user from a plurality of pre-stored sound waveforms (and sound waveforms that are planned to be stored).

When the second training job is started in S814, the server 100B notifies the communication terminal 200B that the second training job has been started, and inquires the communication terminal 200B whether second status information relating to the second training job can be disclosed (step S815). In response to the inquiry, the communication terminal 200B transmits, to the server 100B, a second disclosure instruction to disclose the second status information relating to the second training job (step S804). The server 100B that receives the second disclosure instruction discloses, to the communication terminal 300B (second user), the second status information relating to the second training job executed in S814 (step S816). If the first user does not issue the second disclosure instruction, the server 100B does not disclose the second status information to the second user.

If the first user has agreed in advance to disclose the status information relating to the first or second training job, and a disclosure instruction is issued based thereon, steps S812, S802, S815, and S804 can be omitted. That is, status information relating to the first or second training job can be disclosed to the second user based on the disclosure instruction given in advance by the first user.

The steps S831 to S821 after S816 are basically the same as the steps S621 to S618 in FIG. 6, but are separately executed for each of the first training job and the second training job.

### [3-2. GUI 160B]

Here, one example of the GUI provided to the first user in S815 will be described. FIG. 9 is a diagram showing one example of a disclosure setting GUI for setting disclosure information when training an acoustic model according to one embodiment of this disclosure. The GUI 160B shown in FIG. 9 is displayed on a display unit of the communication terminal 200B of the first user.

As shown in FIG. 9, the GUI 160B is a screen for setting what type of information to disclose when disclosing the status information of the training job. In the present embodiment, disclosure setting item 161B includes first training job item 162B and second training job item 167B. The items of acoustic model name 163B, training sound waveform 164B, expected completion 165B, and training executor 166B are displayed as examples of the detailed information of the first training job item 162B. The items of acoustic model name 168B, training sound waveform 169B, expected completion 170B, and training executor 171B are displayed as examples of the detailed information of the second training job item 167B. Since the above-mentioned items are the same as the items shown in FIG. 7, descriptions thereof are omitted.

In the GUI 160B of FIG. 9, items selected by the user are indicated by the “black square (=)” and items not selected by the user are indicated by the “white square (o).” When the items of the first training job 162B are selected by the first user, all detailed items relating to the first training job are automatically selected. In this case, all of the items relating to the first training job are subject to disclosure. If the items of the second training job item 167B are not selected, the first user can individually select the detailed items relating to the second training job. In the case shown in FIG. 9, only the items of acoustic model name 168B and training sound waveform 169B are selected. In this case, only the selected detailed items relating to the second training job are subject to disclosure. The first communication terminal transmits, to the server 100B, a first disclosure instruction regarding, of the first status information of the first training job, a range of information selected as the subject of disclosure by the first user (S802), and transmits a second disclosure instruction regarding, of the second status information of the second training job, a range of information selected as the subject of disclosure by the first user (S804). That is, the server 100B individually and selectively discloses, to the second user (provides to the communication terminal 300B), the first status information and/or the second status information, based on the disclosure instruction from the first user. Of the plurality of items of the first training job and the second training job, status information corresponding to items for which a disclosure instruction was not received is not disclosed to the second user.

A GUI similar to that described above is also provided in S812, but in said GUI, only items relating to the first training job 162B are displayed.

A disclose button 172B is a button for instructing disclosure of information relating to the acoustic model under training. As a result of the first user pressing the disclose button 172B in S804 of FIG. 8, the disclosure instruction of the disclosure target items selected by the user from among the status information of the first training job and the second training job is transmitted from the communication terminal 200B to the server 100B. The status information of the disclosure target items is disclosed to a third party in a format similar to that shown in FIG. 7 (step S816).

As described above, according to the acoustic model training system 10B of the present embodiment, the first user can individually disclose, to a third party, a plurality of training jobs started by the first user. The first user can freely set items to disclose and items not to disclose for each detailed item of the training job.

### 4. Fourth Embodiment

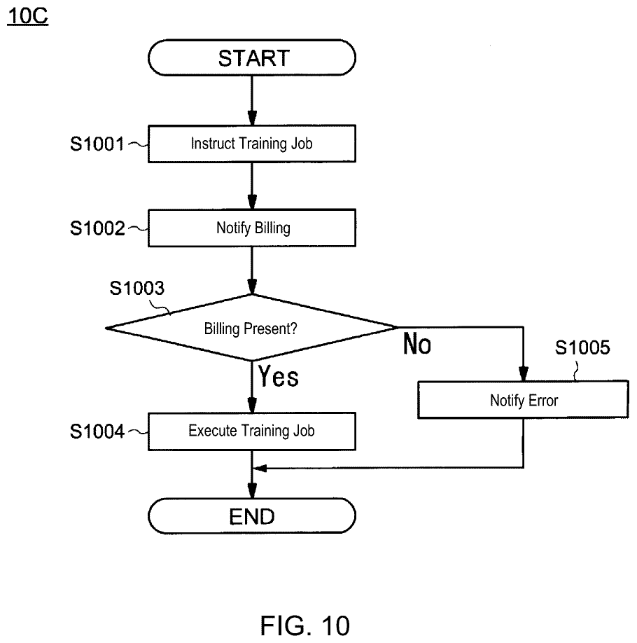

An acoustic model training system 10C according to a fourth embodiment will be described with reference to FIG. 10. The overall configuration of the acoustic model training system 10C and the block diagram relating to the server are the same as those for the acoustic model training system 10 according to the first embodiment, so the explanations thereof are omitted. In the following description, explanations of configurations that are the same as the first embodiment are omitted, and differences from the first embodiment will be mainly explained. In the following description, when describing configurations that are similar to those of the first embodiment, FIGS. 1 to 5 will be referenced, and the alphabet “C” will be added after the reference symbols indicated in these figures.

### [4-1. Sound Synthesis Method]

FIG. 10 is a flowchart showing an acoustic model training method according to one embodiment of this disclosure. In the acoustic model training method shown in FIG. 10, on condition that a user has instructed execution of payment for a bill, a training job for which the user has issued an execution instruction is executed. In FIG. 10, the operation carried out from the training job instruction in S404 of FIG. 4 to the execution of the training job in S413 will be described. Steps S1001 and S1004 in FIG. 10 are respectively the same as S404 and S413 in FIG. 4.

As shown in FIG. 10, in S1001, a communication terminal 200C transmits, to a server 100C, an instruction to execute a training job (first execution instruction). Next, the server 100C that received the execution instruction bills the first user who instructed the execution of the training job, and notifies the communication terminal 200C of information related to the bill (step S1002). After said notification, the server 100C determines whether the communication terminal 200C has paid the bill to the operator of the server 100C (step S1003). If the communication terminal 200C executes the payment (“Yes” in S1003), the server 100C uses the selected to waveform set to execute the training job for which the execution instruction was made on the base acoustic model, within the range of the bill (step S1004). On the other hand, if the communication terminal 200C does not execute the payment (“No” in S1003), the training job is not executed by the server 100C, and an error (non-execution of the training job) is notified to the communication terminal 200C (step S1005). The server 100C can execute the billing process of S1002 each time a control unit of the server 100C performs a training job for a unit time (S1004), and upon receiving payment from the first user (S1003), can execute the training job for the next unit time (S1004) for the acoustic model under training.

As described above, according to the acoustic model training system 10C of the present embodiment, the first user can cause the server 100C to execute a training job that corresponds to the paid amount.

### 5. Fifth Embodiment

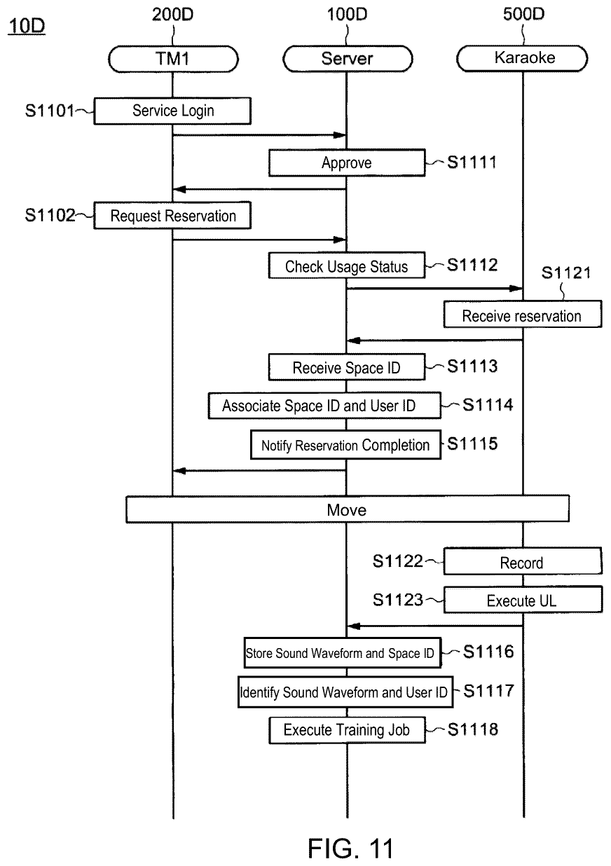

An acoustic model training system 10D according to a fifth embodiment will be described with reference to FIGS. 11 to 14. The overall configuration of the acoustic model training system 10D and the block diagram relating to the server are the same as those for the acoustic model training system 10 according to the first embodiment, so the explanations thereof are omitted. In the following description, explanations of configurations that are the same as the first embodiment are omitted, and differences from the first embodiment will be mainly explained. In the following description, when describing configurations that are similar to those of the first embodiment, FIGS. 1 to 5 will be referenced, and the alphabet “D” will be added after the reference symbols indicated in these figures.

### [5-1. Sound Synthesis Method]

FIG. 11 is a sequence diagram showing a method for recording a sound waveform used for training an acoustic model according to one embodiment of this disclosure. In the recording method shown in FIG. 11, a configuration will be described in which a training sound waveform is recorded and uploaded to a server in a recording space, such as a karaoke box. The recording space is a real space. In the following description, a rental space is illustrated as an example of a recording space.

A karaoke server 500D shown in FIG. 11 is, for example, a server or a computer that controls the renting of karaoke boxes, karaoke booths, etc. The karaoke server 500D manages space IDs and availability. The space ID (identification) is an ID for identifying one rental space from among a plurality of rental spaces, such as karaoke boxes and karaoke booths, provided in one store. The availability indicates whether each rental space is available for use. The rental space can be a completely closed space, such as a karaoke box, or a space that is partially opened to the outside, such as a karaoke booth. A karaoke device provided with a recording function, and a function to communicate with the karaoke server 500D, is installed in each rental space. The karaoke server 500D can connect to a network 400D and communicate with a server 100D via the network 400D. In the present embodiment, the server 100D acts as an agent to perform usage reservation operations of the rental space with respect to the karaoke server 500D. However, while details will be described further below, the invention is not limited to this configuration.

First, a communication terminal 200D logs in to an acoustic model training service provided by the server 100D (step S1101). In S1101, the communication terminal 200D transmits, to the server 100D, account information (for example, user ID (identification) and password) input by a first user using said service. The server 100D performs user authentication based on the account information received from the communication terminal 200D, and authorizes login of the first user to the account of the user ID (step S1111). User authentication can be performed by an external authentication server instead of the server 100D.

The communication terminal 200D requests to reserve a rental space with a desired space ID at a desired date and time for using the service, with the user ID used to log in, in S1111 (step S1102). When the reservation request is received in S1102, the server 100D checks, with the karaoke server 500D, the usage status or availability of the rental space with said space ID at said date and time (step S1112). If the rental space is available, the karaoke server 500D makes a reservation (step S1121), and transmits, to the server 100D, reservation completion information indicating that reservation for the rental space with the space ID has been made for said date and time. In the reservation request, if the first user has specified prepayment, the rental fee and the service usage fee are billed in step S1121. The service usage fee is compensation for the basic training job that is executed after the use of the rental space and that uses waveforms recorded in the rental space. The communication terminal 200D makes a reservation request for a rental space to the karaoke server. Reservation completion information, which includes the user ID and space ID related to the reservation can be transmitted from the karaoke server 500D to the server 100D in response to the reservation request.

When the reservation completion information is received from the karaoke server 500D (step S1113), the server 100D links the space ID related to the reservation completion information with the user ID of the first user (step S1114). Then, the communication terminal 200D is notified that the reservation has been completed (step S1115). The reservation completion notification can be transmitted from the karaoke server 500D to the communication terminal 200D.

When the communication terminal 200D receives the reservation completion notification, the communication terminal 200D displays, to the first user, that the reservation has been completed as well as information specifying the rental space and the date and time of the reservation. Information specifying the rental space described above is the room number of the karaoke box specified by the space ID, for example. When the first user moves to the reserved rental space on the reserved date and time, operates a karaoke device provided in the rental space, and selects a desired musical piece, the accompaniment to the musical piece is played back in the rental space. The first user uses the karaoke device and executes a recording start instruction and a recording end instruction. In response to these instructions, the karaoke server 500D records the singing voice of the first user or the performance sound of a musical instrument (step S1122).

When the usage time of the rental space ends (recording completed), the karaoke server 500D (rental company) bills the usage fee to the first user, if the usage fee for the rental space and the training job has not been prepaid. The first user uses a terminal of the karaoke server 500D to pay the usage fee. Since the usage fee for the training job and the rental fee are a set, the usage fee for the training job can be accordingly discounted from the bill in S1002. The first user selects sound waveforms to be uploaded to the server 100D, from among the sound waveforms (waveform data) for which recording has been completed. Furthermore, if the usage fee for the training job has been paid, the first user selects, from among the sound waveforms to be uploaded, a waveform set to be used for the training job. The karaoke server 500D uploads, to the first user's storage area, the selected sound waveforms and the space ID in which the recording was performed (step S1123). The storage area is specified by the first user's user ID for the server 100D.

The server 100D stores, in the first user's storage area, the uploaded sound waveforms and the space ID in a manner linked to each other (step S1116). One or a plurality of sound waveforms can be uploaded and stored in the server 100D.

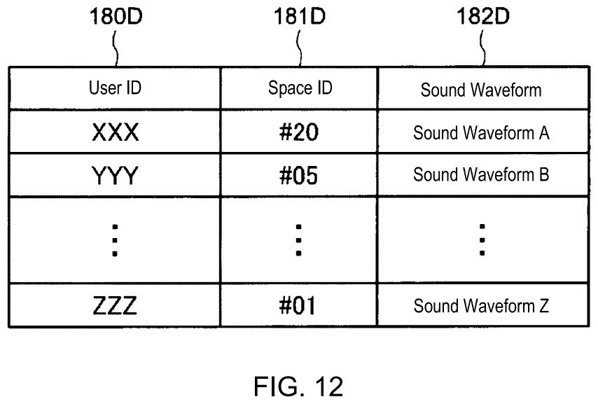

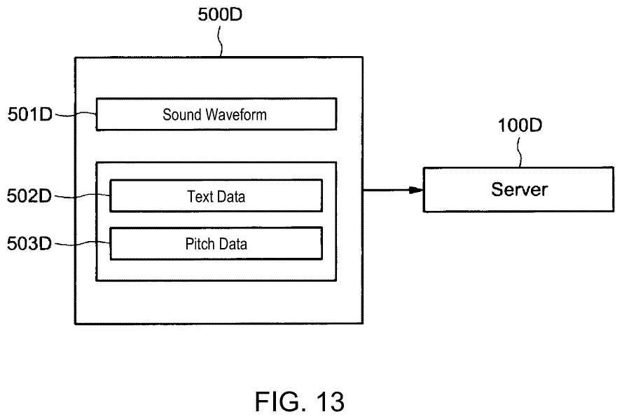

The space ID and the first user's user ID are linked in S1114. The uploaded sound waveform and the space ID are linked in S1116. Accordingly, as shown in FIG. 12, the server 100D links and stores a first user's user ID 180D, a space ID 181D, and uploaded sound waveform 182D. FIG. 12 shows an example of data managed by the server in one embodiment of this disclosure. The user ID 180D is the user ID of the account used to log in, in S1111 of FIG. 11. Each piece of data in FIG. 13, described further below, is stored in the storage area corresponding to the user ID. The space ID 181D is the space ID of the space in which the recording was performed in S1122 of FIG. 11. The sound waveform 182D is the sound waveform recorded in S1122 of FIG. 11 and transmitted to the server 100D in S1123.

The server 100D identifies the user ID of the first user who uploaded a sound waveform from the storage area to which the sound waveform was uploaded in S1123 (step S1117). Then, based on an instruction from the first user, the server 100D uses a new sound source ID and the uploaded sound waveform to execute a training job for the base acoustic model (step S1118).

Here, the data uploaded from the karaoke server 500D to the server 100D in S1123 will be described with reference to FIG. 13. FIG. 11 illustrates a configuration in which only sound waveforms representing the first user's singing voice or performance sounds are uploaded to the server 100D in S1123, but the invention is not limited to this configuration. For example, in the case that a singing voice is uploaded, as shown in FIG. 13, pitch data 503D indicating sounds constituting a guide melody of the musical piece supplied to the rental space by the karaoke device and text data 502D representing the lyrics of the musical piece can be uploaded to the server 100D, together with said sound waveform 501D. In the case that performance sounds are uploaded, the text data 502D are not uploaded.

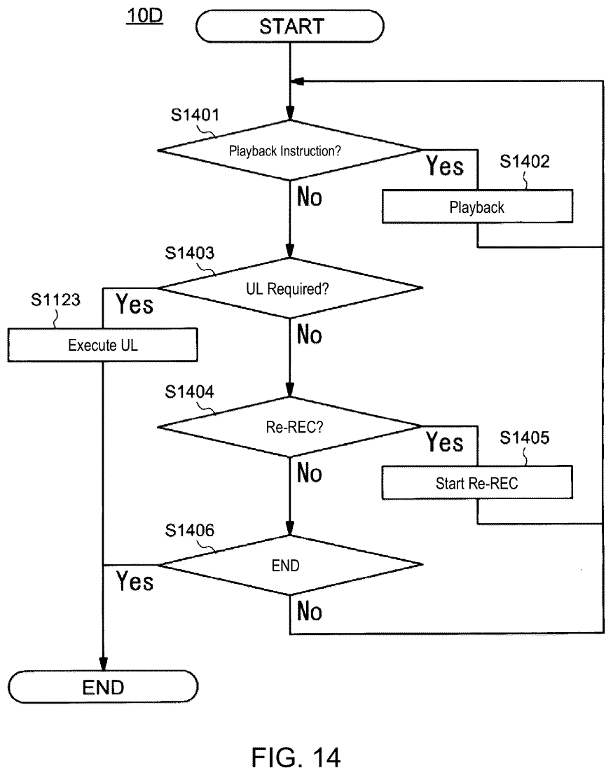

Steps by which the karaoke server 500D uploads data recorded in S1122 to the server 100D in S1123 will be described with reference to FIG. 14. FIG. 11 illustrates a configuration in which sound waveforms recorded in S1122 are uploaded to the server 100D in S1123 without undergoing any particular steps, but the invention is not limited to this configuration. For example, as shown in FIG. 14, the first user can determine, after sound data relating to a recorded sound waveform are played back, whether it is necessary to upload the sound waveform. In the example of FIG. 14, the karaoke device or the communication terminal 200D is used to inquire the first user whether it is necessary to play back the recorded sound waveform, whether it is necessary to upload said sound waveform, whether it is necessary to re-record, and whether it is necessary to end the operation. These four inquiries can be displayed sequentially on a single GUI, or be displayed as a play button, an upload button, a re-record button, and an end button displayed next to each other on the GUI.

After recording of the sound data is completed in S1122 of FIG. 11, the karaoke server 500D determines presence/absence of a playback instruction from the first user, as shown in FIG. 14 (step S1401). If there is a playback instruction in S1401 (“Yes” in S1401), the karaoke server 500D uses the karaoke device and plays back the sound data recorded in S1122 of FIG. 11 in the rental space in which the recording was performed (step S1402). At the time of said playback, the sound data only can be played back, or the sound data can be played back with a guide melody. After the playback is carried out in S1402, the process returns to step S1401. If there is no playback instruction in S1401 (“No” in S1401), the playback of S1402 is not executed, and the process proceeds to the subsequent step.

Next, it is determined whether it is necessary to upload the sound data recorded in S1122 of FIG. 11 (step S1403). For example, the karaoke server 500D provides, to the first user, a GUI for selecting whether to upload the recorded sound data, and determines whether it is necessary to upload in accordance with the first user's selection.

If it is determined that upload is necessary in S1403 (“Yes” in S1403), the upload of S1123 in FIG. 11 is executed, and the above-mentioned operation is ended. On the other hand, if there is no instruction to execute an upload in S1403 (“No” in S1403), it is determined whether it is necessary to re-record (step S1404). For example, the karaoke server 500D provides, to the first user, a GUI for selecting whether to re-record, and determines whether it is necessary to re-record in accordance with the first user's selection.

If it is determined that it is necessary to re-record in S1404 (“Yes” in S1404), the karaoke server 500D performs re-recording in the same manner as S1122 of FIG. 11 (step S1405). When the re-cording of S1405 ends, presence/absence of a playback instruction is determined again in S1401. If there is no instruction to start re-recording in S1404 (“No” in S1404), it is determined whether the operation can be ended (step S1406). If it is determined in S1406 that the operation can be ended (“Yes” in S1406), the above-mentioned operation is ended. On the other hand, if there is no instruction to end the operation in S1406 (“No” in S1406), the process returns to step S1401. If there is no playback instruction in S1401, no upload execution instruction in S1403, no instruction to start re-recording in S1404, and no instruction to end in S1406, the karaoke server 500D repeatedly executes these determination steps.

In the present embodiment, an example is shown in which the server 100D acts as an agent to perform usage reservation operations of the rental space with respect to the karaoke server 500D, but the invention is not limited to this configuration. For example, the karaoke server 500D can carry out usage reservation operations of the rental space. In that case, the server 100D and the karaoke server 500D share first account information of the first user. Furthermore, the server 100D stores the sound waveform and the space ID received from the karaoke server 500D, linked with the user ID (first account information) of the first user. The subsequent steps are the same as those after S1122 in FIG. 11.

The recording start instruction and the recording end instruction in S1122 of FIG. 11 can be executed with the start and end of a musical piece, or can be executed by any operation of the first user. That is, only sound data of a specified period from among the playback period of the musical piece can be recorded based on the first user's recording instruction. The recording start instruction and the recording end instruction can be executed using a karaoke device or executed using a communication terminal 200D. That is, the recording in S1122 can be executed only for a portion of the playback period of the musical piece. In other words, as shown in FIG. 13, the server 100D can receive, from the karaoke server 500D, pitch data 503D representing sounds of the parts of a musical piece sung or played by the first user, and text data 502D representing the lyrics of the musical piece, provided in the rental space, together with a sound waveform 501D which is sound data of a recording of singing during at least a portion of the playback period of the musical piece. Then, the server 100D stores the sound waveform 501D of the singing or performance sounds as the training sound waveform, linked with the musical score data.

As described above, according to the acoustic model training system 10D of the present embodiment, it is possible to use a karaoke box, etc., to record and upload sound data to the server 100D, thereby reducing the effort required of the first user to prepare an environment for recording sound data.

### 6. Sixth Embodiment

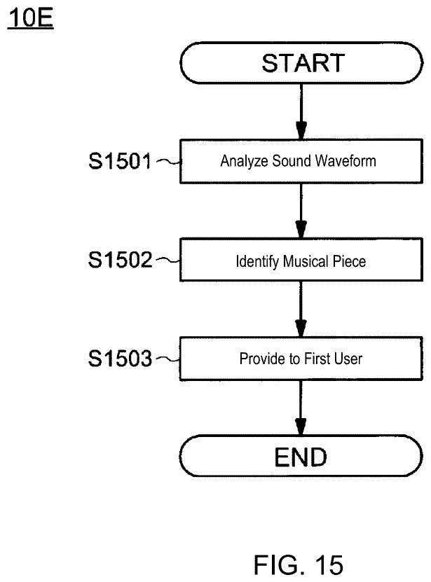

An acoustic model training system 10E according to a sixth embodiment will be described with reference to FIG. 15. The overall configuration of the acoustic model training system 10E and the block diagram relating to the server are the same as those for the acoustic model training system 10 according to the first embodiment, so the explanations thereof are omitted. In the following description, explanations of configurations that are the same as the first embodiment are omitted, and differences from the first embodiment will be mainly explained. In the following description, when describing configurations that are similar to those of the first embodiment, FIGS. 1 to 5 will be referenced, and the alphabet “E” will be added after the reference symbols indicated in these figures.

### [6-1. Sound Synthesis Method]

FIG. 15 is a flowchart showing a method for recommending a musical piece suitable for training an acoustic model, which is an objective of one embodiment of this disclosure. In the recommendation method shown in FIG. 15, a configuration in which a musical piece suitable for sound waveforms are recommended to a first user based on some or all of the sound waveforms pre-stored in a server 100E as training sound waveforms, or a configuration in which a musical piece suitable for said sound waveforms is recommended to the first user based on a waveform set selected by the user, will be described. A communication terminal 100E receives, in advance from a first user, information indicating the usage range of the acoustic model regarding the pitch or acoustic features that the first user envisions.

First, the server 100E analyzes pre-stored training sound waveforms or a selected waveform set (step S1501). The training sound waveforms to be analyzed are not all of the stored training sound waveforms but a portion of the sound waveforms of a specific sound source (a specific singer or a specific musical instrument). For example, folders for each singer or each musical instrument can be provided in the first user's storage area in the server 100E, training sound waveforms can be separately stored in folders corresponding to the singer or musical instrument, and the analysis can be individually performed on the sound waveform stored in each folder. A waveform set is a set of sound waveforms of a specific singer or a specific musical instrument that the first user selects to train the acoustic model of the specific singer or the specific musical instrument. Said analysis is carried out based on the pitch or acoustic features of the sound waveform, for example. Furthermore, if the musical piece for which analysis of the sound waveforms was carried out is known, the sound waveforms can be compared with the musical score data of the performance sounds or the singing of the musical piece to determine the singing or playing skill, in terms of pitch, timbre, dynamics, etc. Alternatively, it is possible to determine, from the analysis, the singing style, the performance style, the vocal range, or the performance sound range.

Singing style is the way of singing. Performance style is a way of playing. Specifically, examples of singing styles include neutral, vibrato, husky, vocal fry, and growl. Examples of performance styles include, for bowed string instruments, neutral, vibrato, pizzicato, spiccato, flageolet, and tremolo, and for plucking string instruments, neutral, positioning, legato, slide, and slap/mute. For the clarinet, performance styles include neutral, staccato, vibrato, and trill. For example, the above-mentioned vibrato means a singing style or a performance style that frequently uses vibrato. The pitch, volume, timbre, and dynamic behaviors thereof in singing or playing change overall with the style. In a training job, the server 100E can input, in addition to a new sound source ID and a waveform set, the singing style or the performance style obtained by the analysis of said waveform set, and train a base acoustic model 120E.

The vocal range and the performance sound range of a training sound waveform are determined from the distribution of pitches in a plurality of sound waveforms of the performance sounds of a specific musical instrument and of the singing of a specific singer, and indicate the range of the sound waveforms of the singer or the musical instrument.

With regard to the timbre of a specific sound source, if the planned usage range of pitch data and acoustic features has not been entirely covered, the server 100E determines that the acoustic model has not been sufficiently trained for the prepared training sound waveforms. By performing the analysis of S1501, the server 100E detects, from all the ranges in which the timbre of the specific sound source is to be used, ranges in which there is little or no sound waveforms. Then, the server 100E identifies one or more musical pieces to recommend to the first user in order to fill the ranges for which data are insufficient (step S1502). Then, the information indicating the musical pieces identified in S1502 is provided to a communication terminal 200E (first user) (step S1503), and the communication terminal 200E displays the information that has been received on a display unit thereof.

As described above, according to the acoustic model training system 10E of the present embodiment, when the sound waveform prepared as the training sound waveform cannot cover the planned usage range, the first user is notified of this point, so that the first user can prepare training sound waveforms that fully cover the planned usage range.

This disclosure is not limited to the embodiments described above, and can be modified within the scope of the spirit of this disclosure. The embodiments can be combined with each other as long as technical contradictions do not occur.

### 7. Seventh Embodiment

### [7-1. Overall System Configuration]

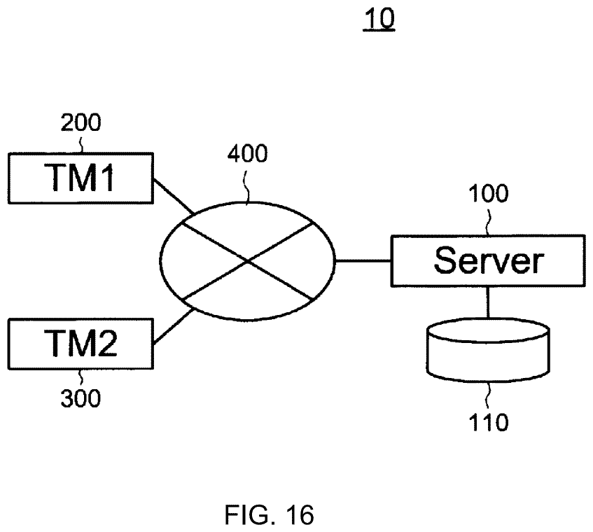

FIG. 16 is a diagram showing an overall configuration of an acoustic model training system according to one embodiment of this disclosure. As shown in FIG. 16, an acoustic model training system 10 comprises a server 100 (server), a communication terminal 200 (TM1), and a communication terminal 300 (TM2). The server 100 and the communication terminals 200, 300 can each connect to a network 400. The communication terminal 200 and the communication terminal 300 can each communicate with the server 100 via the network 400.

In the present embodiment, the server 100 is a computer that functions as a sound synthesizer and carries out training of acoustic models. The server 100 is provided with storage 110. FIG. 16 illustrates a configuration in which the storage 110 is directly connected to the server 100, but the invention is not limited to this configuration. For example, the storage 110 can be connected to the network 400 directly or via another computer, and data can be received and transmitted between the server 100 and the storage 110 via the network 400.

The communication terminal 200 is a terminal for selecting a training sound waveform for training an acoustic model and sending an instruction to the server 100 to execute the training. The communication terminal 300 is a terminal that is different from the communication terminal 200 and that can access the server 100. For example, the communication terminal 300 is a terminal that provides sound waveforms for synthesis and requests the server 100 to generate synthetic sound waveforms. The communication terminals 200, 300 include mobile communication terminals, such as smartphones or tablet terminals, and stationary communication terminals such as desktop computers.

The network 400 can be the Internet provided by a common World Wide Web (WWW) service, a Wide Area Network (WAN), or a Local Area Network (LAN), such as a corporate LAN.

### [7-2. Configuration of a Server Used for Sound Synthesis]

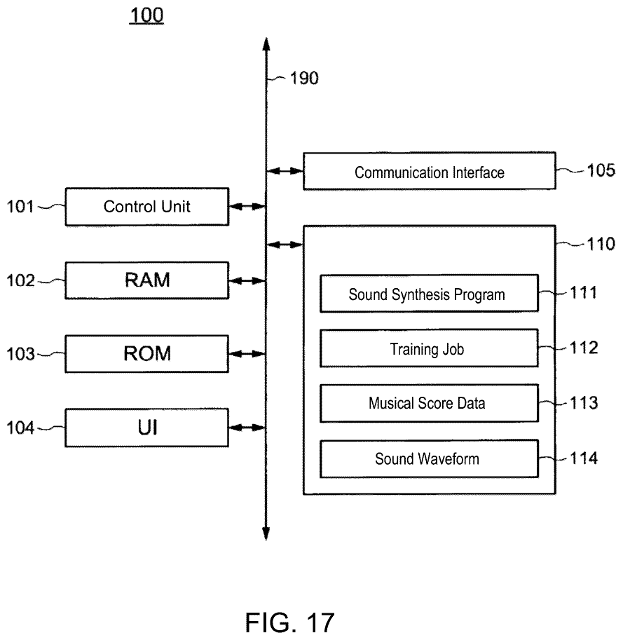

FIG. 17 is a block diagram showing a configuration of a server according to one embodiment of this disclosure. As shown in FIG. 17, the server 100 comprises a control unit (electronic controller) 101, random access memory (RAM) 102, read only memory (ROM) 103, a user interface (UI) 104, a communication interface 105, and the storage 110. The sound synthesis technology of the present embodiment is realized by cooperation between each of the functional units of the server 100.

The control unit 101 includes at least one or more processors, such as a central processing unit (CPU) or a graphics processing unit (GPU), and at least one or more storage devices such as registers and memory connected to said processors. The control unit 101 executes, with the CPU and the GPU, programs temporarily stored in the memory, to realize each of the functions provided in the server 100. Specifically, the control unit 101 performs computational processing in accordance with various types of request signals from the communication terminal 200 and provides content data to the communication terminals 200 and 300.

The RAM 102 temporarily stores content data, acoustic models (composed of an architecture and variables), control programs necessary for the computational processing, and the like. The RAM 102 is used, for example, as a data buffer, and temporarily stores various data received from an external device, such as the communication terminal 200, until the data are stored in the storage 110. General-purpose memory, such as static random access memory (SRAM) or dynamic random access memory (DRAM), can be used as the RAM 102.

The ROM 103 stores various programs, various acoustic models, parameters, etc., for realizing the functions of the server 100. The programs, acoustic models, parameters, etc., stored in the ROM 103 are read and executed or used by the control unit 101 as needed.

The user interface 104, by the control of the control unit 101, displays various display images, such as a graphical user interface (GUI), on a display unit thereof, and receives input from a user of the server 100.

The communication interface 105 is an interface for connecting to the network 400 and sending and receiving information with other communication devices such as the communication terminals 200, 300 connected to the network 400, by the control of the control unit 101.

The storage 110 is a recording device (storage medium) capable of permanent information storage and rewriting, such as nonvolatile memory or a hard disk drive. The storage 110 stores information such as programs, acoustic models, and parameters, etc., required to execute said programs. As shown in FIG. 17, the storage 110 stores a sound synthesis program 111, a training job 112, musical score data 113, and a sound waveform 114. Programs and data related to common sound synthesis can be used as the above-mentioned programs and data, such as the sound synthesis program P1, the training program P2, the musical score data D1, and the audio data D2 disclosed in International Publication no. 2022/080395.

As described above, the sound synthesis program 111 is a program for generating synthetic sound waveforms from musical score data or sound waveforms. When the control unit 101 executes the sound synthesis program 111, the control unit 101 uses an acoustic model 120 to generate a synthetic sound waveform. The synthetic sound waveform corresponds to the audio data D3 disclosed in International Publication no. 2022/080395. The training program for the acoustic model 120 executed by the control unit 101 in the training job 112 is, for example, the program for training an encoder and an acoustic decoder disclosed in International Publication no. 2022/080395. The musical score data are data that define a musical piece. The sound waveform is waveform data of a voice or a performance sound, such as waveform data representing a singer's singing voice or a performance sound of a musical instrument.

### [7-3. Functional Configuration of a Server Used for Sound Synthesis]

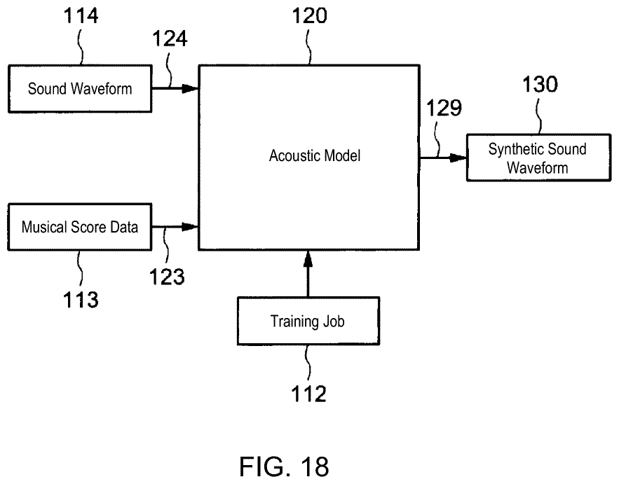

FIG. 18 is a block diagram showing the concept of an acoustic model according to one embodiment of this disclosure. As described above, the acoustic model 120 is a machine learning model used in sound synthesis technology executed by the control unit 101 of FIG. 17, when the control unit 101 reads and executes the sound synthesis program 111. The acoustic model 120 generates acoustic features 129. Musical score features 123 of the musical score data 113 or acoustic features 124 of the sound waveform 114 of a desired musical piece are input to the acoustic model 120 as an input signal by the control unit 101. The sound source ID and the musical score features 123 are processed using the acoustic model 120, thereby generating acoustic features 129 of the synthesized sound of the musical piece. Based on the acoustic features 129, the control unit 101 synthesizes the musical piece with the synthetic sound waveform 130 sung by the singer or played by a musical instrument specified by the sound source ID, and outputs the synthesized result. Alternatively, the sound source ID and the acoustic features 124 are processed using the acoustic model 120, thereby generating acoustic features 129 of the synthesized sound of the musical piece. Based on the acoustic features 129, the control unit 101 synthesizes and outputs the synthetic sound waveform 130, in which the sound waveform of the musical piece is converted to the timbre of the singing of the singer or the performance sound of the musical instrument specified by the sound source ID.

The acoustic model 120 is a generative model that uses machine learning. The acoustic model 120 is trained by the control unit 101 executing a training program (i.e., executing the training job 112). The control unit 101 uses (an unused) new sound source ID and a sound waveform for training to train the acoustic model 120 and determines the variables of the acoustic model 120 (at least the acoustic decoder). Specifically, the control unit 101 generates acoustic features for training from the sound waveform for training, and when a new sound source ID and acoustic features for training are input to the acoustic model 120, the control unit 101 gradually and repeatedly changes the variables described above such that the acoustic features for generating the synthetic sound waveform 130 approach the acoustic features for training. The sound waveform for training can be uploaded (transmitted) to the server 100 from the communication terminal 200 or the communication terminal 300 and stored in the storage 110 as user data, or can be stored in the storage 110 in advance by an administrator of the server 100 as reference data. In the following description, storing in the storage 110 can be referred to as storing in the server 100.

### [7-4. Sound Synthesis Method]

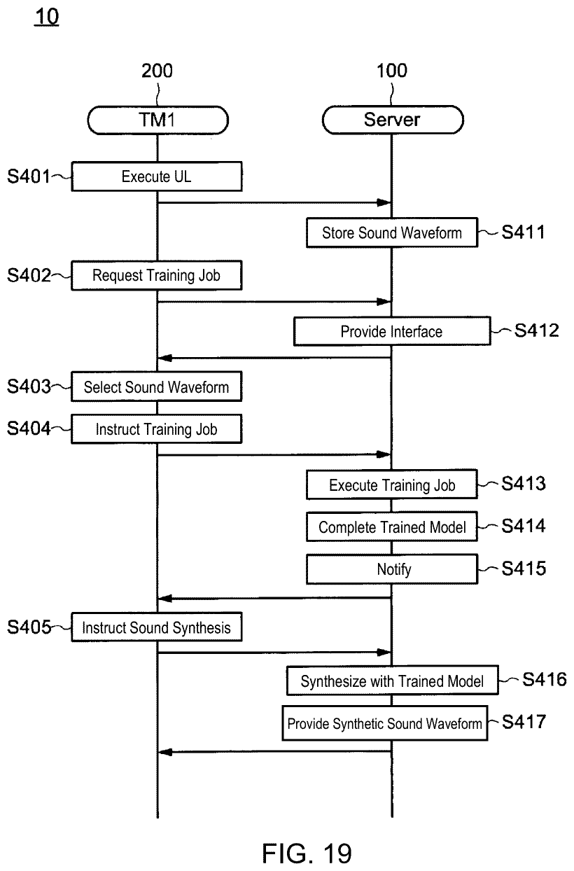

FIG. 19 is a sequence diagram showing an acoustic model training method and a sound synthesis method according to one embodiment of this disclosure. In the acoustic model training method shown in FIG. 19, an example is shown in which the communication terminal 200 uploads a sound waveform for training to the server 100, and instructs a training job and sound synthesis. However, as described above, the sound waveform for training can be pre-stored in the server 100 by other means. The training job in the sequence shown in FIG. 19 can be referred to as the “first training job.” Each step of the process TM1 on the communication terminal 200 side and each step of the process on the server 100 side are actually executed by a control unit of the communication terminal 200 and the control unit 101 of the server 100. However, for simplicity of explanation, the communication terminal 200 and the server 100 are represented as the means for executing each of the steps. Unless otherwise specified, the same applies to the explanations of the subsequent sequence diagrams and flowcharts.

As shown in FIG. 19, first, the communication terminal 200 uploads (transmits) one or more sound waveforms for training to the server 100, based on an instruction from a first user that has logged in to the first user's account on the server 100 (step S401). The server 100 stores the sound waveform for training transmitted in S401 to the first user's storage area (step S411). One or more sound waveforms can be uploaded to the server 100. The plurality of sound waveforms can be separately stored in a plurality of folders in the first user's storage area. Steps S401, 411 described above are steps relating to preparation for executing the following training job.

Steps for executing a training job will be described next. The communication terminal 200 requests the server 100 to execute a training job (step S402). In response to the request made in S402, the server 100 provides the communication terminal 200 with a graphical user interface (GUI) for selecting, from among pre-stored sound waveforms (and sound waveforms that are planned to be stored), sound waveforms to be used for the training job.

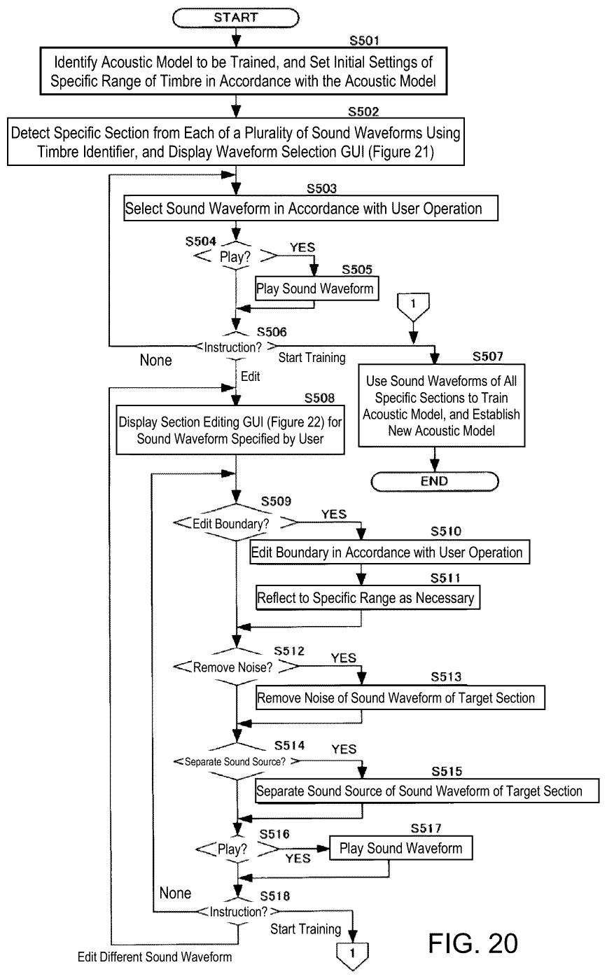

The communication terminal 200 displays, on the display unit thereof, the GUI provided in S412. The first user uses the GUI to select, as a waveform set 149 (refer to FIG. 20), one or more sound waveforms for training from among the plurality of sound waveforms uploaded in the storage area (or a desired folder) (step S403). After the waveform set 149 (sound waveform for training) is selected in S403, the communication terminal 200 instructs the start of execution of the training job in response to an instruction from the first user (step S404).

Based on the instruction from the communication terminal 200 in S404, the server 100 starts the execution of the training job using the selected waveform set 149 (step S413). In other words, in S413, the training job is executed based on the first user's instruction provided via the GUI in S412.

Not all of the waveforms in the selected waveform set 149 are used for training; rather, a preprocessed waveform set that includes only useful sections and excludes silent sections and noise sections is used. The acoustic model 120 in which the acoustic decoder is untrained can be used as the acoustic model 120 (base acoustic model) to be trained. However, by selecting and using, as the acoustic model 120 to be trained, the acoustic model 120 containing an acoustic decoder that has learned to generate acoustic features that are similar to the acoustic features of waveforms in the waveform set 149, from among of the plurality of acoustic models 120 already subjected to basic training, it is possible to reduce the time and cost required for the training job. Regardless of which acoustic model 120 is selected, a musical score encoder and an acoustic encoder that have been subjected to basic training are used.

The base acoustic model can be determined by the server 100 based on the waveform set 149 selected by the first user. Alternatively, the first user can select, as the base acoustic model, one of a plurality of trained acoustic models. The first execution instruction can include designation data indicating the base acoustic model. An unused new sound source ID is used as the sound source ID (for example, singer ID, instrument ID, etc.) supplied to the acoustic decoder. Here, the user does not necessarily need to know which sound source ID has been used as the new sound source ID. However, when performing sound synthesis using a trained model, the new sound source ID is automatically used.

In a training job, unit training is repeated, in which partial short waveforms are extracted little by little from a preprocessed waveform set, and the extracted short waveforms are used to train the acoustic model (at least the acoustic decoder). In unit training, the new sound source ID and the acoustic features of the short waveform are input to the acoustic model 120, and the variables of the acoustic model are adjusted accordingly so as to reduce the difference between the acoustic features output by the acoustic model 120 and the acoustic features that have been input. For example, backpropagation method is used for the adjustment of the variables. Once training using a preprocessed waveform set is completed by repeating unit training, the quality of the acoustic features generated by the acoustic model 120 is evaluated, and if the quality does not meet a prescribed standard, the preprocessed waveform set is used to train the acoustic model again. If the quality of the acoustic features generated by the acoustic model 120 meets the prescribed standard, the training job is completed, and the acoustic model 120 at that time point becomes the trained acoustic model 120.

When the training job is completed in S413, the trained acoustic model 120 is established (step S414). The server 100 notifies the communication terminal 200 that the trained acoustic model 120 has been established (step S415). The steps S403 to S415 described above are the training job for the acoustic model 120.

After the notification of S415, the communication terminal 200 transmits, to the server 100, an instruction for sound synthesis, including the musical score data of the desired musical piece, in accordance with an instruction from the first user (step S405). In response, the server 100 executes a sound synthesis program, and executes sound synthesis using the trained acoustic model 120 completed in S414 based on the musical score data (step S416). The synthetic sound waveform 130 generated in S416 is transmitted to the communication terminal 200 (step S417). The new sound source ID is used in this sound synthesis.

It can be said that, S416 in combination with S417 provides the trained acoustic model 120 (sound synthesis function) trained by the training job to the communication terminal 200 (first device) or the first user. The execution of the sound synthesis program of step S416 can be carried out by the communication terminal 200 instead of the server 100. In that case, the server 100 transmits the trained acoustic model 120 to the communication terminal 200. The communication terminal 200 uses the trained acoustic model 120 that has been received to execute a sound synthesis process based on the musical score data of the desired musical piece with the new sound source ID, to obtain the synthetic sound waveform 130.

In the present embodiment, before execution of the training job is requested in S402, the sound waveform for training is uploaded in S401, but the invention is not limited to this configuration. For example, the upload of the sound waveform for training can be carried out after execution of the training job is instructed in S404. In this case, in S403, one or more sound waveforms can be selected, as the waveform set 149, from a plurality of sound waveforms (including sound waveforms that have not been uploaded) stored in the communication terminal 200, and, of the selected sound waveforms, sound waveforms that have not been uploaded can be uploaded in accordance with an instruction to execute a training job.

### [7-5. Sound Waveform Preprocessing and Acoustic Model Training Method]

FIG. 20 is a flowchart showing an acoustic model training method according to one embodiment of this disclosure. The flowchart shown in FIG. 20 shows a training process in which the communication terminal 200 and the server 100 execute in cooperation in S402 to S404 as well as S412 to S414 in FIG. 19. As described above, the system of the present embodiment is not limited to the configuration of a client server, and can be a standalone system or a distributed system. Accordingly, in the following description, it will be expressed that a system (one or more processors of a system), as a generic concept, executes various processes. In the training job instructed in S404, a plurality of the sound waveforms 114 are used to train the acoustic model 120 of FIG. 18. Through the operation shown in FIG. 20, the system selects the sound waveforms to be used for training based on a user's operation via the GUI, edits, as necessary, a specific section detected automatically, and trains the acoustic model using the sound waveform of the specific section.

When the user requests a training job (S402 of FIG. 19), the user specifics one acoustic model to be used for training from among a plurality of trained acoustic models. The training process shown in FIG. 20 is initiated in response to the request. The system identifies the acoustic model specified by the user, and sets the initial settings of a specific range for detecting a timbre with the same tendencies as the sound waveform used for training the acoustic model (that is, a timbre within the specific range) (step S501). For example, if an acoustic model trained with a voice of male voice 4 is specified, the specific range is initially set so as to identify sounds with a timbre similar to the male voice 4.

Next, the system detects, from each of a plurality of sound waveforms that are stored (in the server 100, for example), sections (sound-containing sections) containing sound exceeding a prescribed level, and detects, from the plurality of detected sound-containing sections, various timbres and noise using a timbre identifier. The system, based on the detection result, detects various sections containing specific sections to be used for training, and, based on the detection result thereof, displays a graphical user interface (GUI) 600 for selecting waveforms on a display unit (for example, the display unit of the communication terminal 200) (step S502).

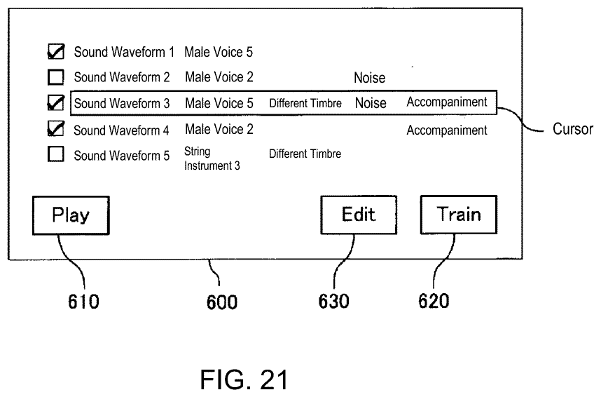

The GUI 600 is an interface through which selection of the sound waveforms to be used for the training of the acoustic model is received from the user. This GUI displays the names of sound waveforms stored in specific folders of the system, and various information based on the results of detection by the timbre identifier. For example, in FIG. 21, for each sound waveform, the timbre of the main component (such as “male voice 5”) determined from the sound waveform, the presence of a section containing a different timbre (“different timbre”) in the sound waveform, the presence of a section containing noise (“noise”), and the presence of a section containing accompaniment sounds (“accompaniment”) are displayed associated with the name of the sound waveform.

In step S502, the timbre identifier estimates, along a time axis, the possibility that a sound waveform corresponds to any one of a plurality of types of timbre and noise. The types of timbre that can be identified are male voice, female voice, brass instrument, woodwind instrument, string instrument, plucked string instrument, percussion instrument, and the like. The system detects, from among the plurality of timbres, the timbre estimated to be the most likely timbre, as the “main timbre.” The timbre range set in step S501 contains one or more timbres that can be identified by the timbre identifier.

In step S502, when the main timbre of the sound signal of a certain section is contained in a specific range, and the possibility of there being noise and a timbre outside of the specific range is lower than a threshold value, the system determines the section to be a “specific section.” If the possibility of there being a timbre outside of the specific range is higher than a prescribed threshold, the system determines whether the timbre outside of the specific range is the same type as the timbre within the specific range. If the type is the same, the system determines the section to be a “different-timbre-containing section,” and if the types are different, the system determines the section to be an “accompaniment-containing section.” If the possibility of there being noise is higher than a prescribed threshold, the system determines the section to be a “noise-containing section.”

In the GUI 600, when the user checks a check box next to the name of a desired sound waveform (selection operation by the user), the system selects the checked sound waveform as the sound waveform used for training (step S503). For example, in FIG. 21, sound waveforms 1, 3, and 4 are selected. When the user places the cursor on the desired sound waveform and operates the “Play” button 610 on the screen (“Yes” in step S504), the system plays a sound of the sound waveform specified by the cursor (step S505). The user can select a sound waveform while aurally checking the sound. The selection process of the sound waveform and the play process described above is continued until the user instructs to “edit sound waveform” or “start training” (repeating steps S503 to S506).

When the user operates the “Train” button 620 in the GUI to instruct the start of training (“start training” in step S506), the system uses, from among the selected sound waveforms, the sound waveforms of the specific sections to start the training job for the identified acoustic model (step S507). If the training job is executed by a client-server configuration, a training job execution instruction is transmitted from the communication terminal 200 to the server 100 at this time. As described in relation to FIG. 19, this training job establishes an acoustic model that has the ability to generate sound waveforms that have characteristics similar to the sound waveforms used for training. In this disclosure, since training is performed using, from among the prepared sound waveforms, sound waveforms of a specific section in which the timbre is within a specific range, the time required for the training is shortened, and the quality of the acoustic model that is established improves.

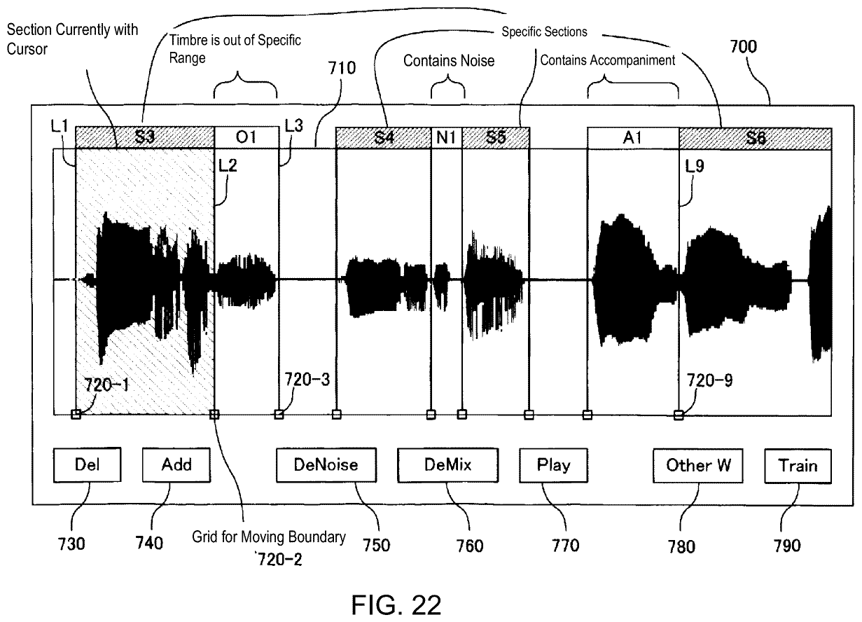

In response to the user's operation of the “Edit” button 630 (“edit” in S506), the system starts a process (steps S508 to S518) of editing the specific section of a sound waveform (for example, sound waveform 3) specified by the cursor. As shown in FIG. 22, the system displays a GUI (FIG. 22) for the user to edit sections of the sound waveform used for the training process for the acoustic model (step S508).

As shown in FIG. 22, the GUI 700 is provided with a waveform display section 710 for displaying the sound waveform as a graph, grids 720 for moving boundaries, and seven operating buttons 730-790. The horizontal axis of the waveform display section 710 is time, and the vertical axis indicates the sample value of the sound waveform. For example, a range of about one minute, which is a portion of the sound waveform 3, is displayed compressed in the time direction in the waveform display section 710 of FIG. 22. Because the waveform display section 710 is small-scale, individual samples of the sound waveform are not visible in the waveform display section 710, while the amplitude envelope of the sound waveform is visible. Bands indicating various sections detected from the sound waveform in step S502 are displayed along the time axis in the upper part of the waveform display section 710.

For example, in FIG. 22, bands indicating specific sections S3 to S6, different timbre section O1, noise-containing section N1, and accompaniment-containing section A1 are displayed. Specific sections, noise-containing sections, and accompaniment-containing sections are sections in which the system has determined that the main timbre of the sound waveform is within a specific range. The different timbre section O1 is a section in which the system has determined that the main timbre is not within a specific range. The specific sections S3 to S6 are sections obtained by removing, from sections in which it is determined that the main timbre is within a specific range, the noise-containing section N1 containing noise and the accompaniment-containing section A1 containing the accompaniment. Of the time axis of the sound waveform, sections in which no band is displayed are silent sections in which the sound level is below a prescribed level.

In the waveform display section 710 of FIG. 22, boundaries indicating the start point and the end point of each of the sections S3 to S6, O1, N1, and A1 are displayed. For example, boundaries L1 and L2 are the start point and the end point of the specific section S1. The boundaries L2 and L3 are the starting point and the end point of the different timbre section O1. These boundaries can be moved, added, or deleted by editing operations of the user.

In the GUI 700, if the user performs an editing operation on any of the boundaries (“Yes” in step S509), the system edits the boundary in accordance with the user operation (step S510).

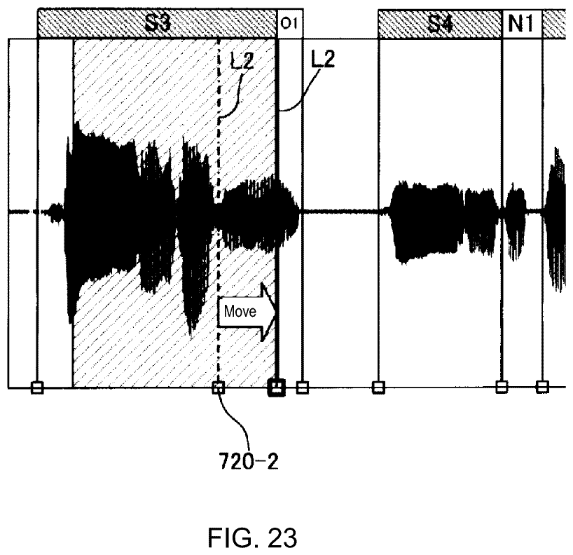

FIG. 23 is a diagram showing a case in which a moving operation of the boundary L2 is carried out. For example, if the user drags the grid 720-2 of the boundary L2 to the right (moving operation in the right direction), the system moves the boundary L2 together with the grid 720-2 to the right. As a result, the specific section S3 expands to the right, and the different timbre section O1 shrinks to the right.

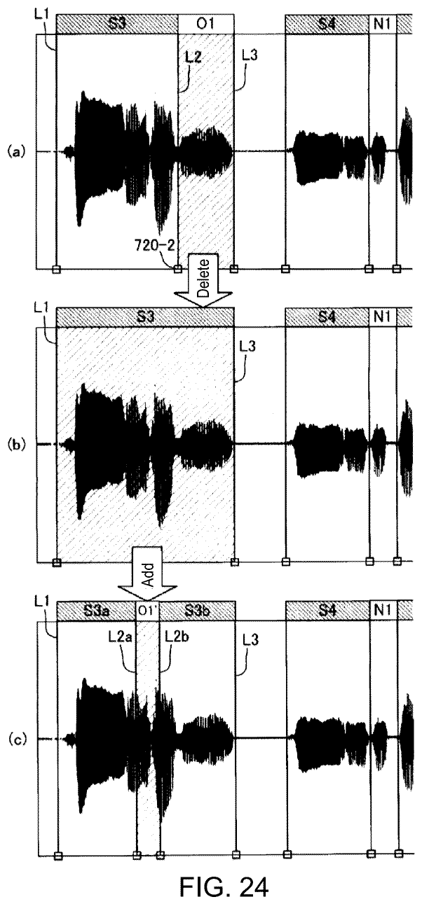

FIG. 24 is a diagram showing a case in which, after a deletion operation using a “Delete (Del)” button 730, an addition operation using an “Add” button 740 is carried out. When the user specifies the different timbre section O1 with the cursor and selects the “Delete” button 730, the system deletes the boundary L2, expands the specific section S3 (FIG. 24(a)) to a section from the boundary L1 to the boundary L3, and deletes the different timbre section O1 (FIG. 24(b)).

Next, if the user presses the “Add” button 740 with the cursor in the specific section S3, the system adds two boundaries L2a, L2b inside the specific section S3 (FIG. 24(b)) to divide the specific section S3 into the specific section S3a, the different timbre section O1′, and the specific section S3b (FIG. 24(c)). As a result, the middle part of the existing specific section S3 is changed to the different timbre section O1 that is excluded from training. The user can specify either one of L2a or L2b as a boundary to be added, to change either the front portion or the rear portion of the specific section S3 to the different timbre section O1. When only the boundary L2a is added, the specific section S3 is divided into the specific section S3a and the different timbre section O1′. When only the boundary L2b is added, the specific section S3 is divided into the different timbre section O1′ and the specific section S3b.

As a result of editing the boundaries in step S510, the specific section is expanded in some parts of the sound waveform (FIG. 23, FIG. 24(b)). On the other hand, the specific section is shrunk in other parts (FIG. 24(c)). If the user wishes to include the timbre of the sound waveform of an expanded portion of the specific section in the specific range, or if the user wishes to exclude, from the specific range, the timbre of the sound waveform of a portion of the specific section (shrunk portion of the specific section), the user instructs a “reflect request” to the system. When a “reflect request” is instructed, the system expands the specific range so that the timbre of the expanded portion is included, or shrinks the specific range so as to exclude the timbre of the shrunk portion (step S511). As a result, the detection of various sections containing specific sections from the plurality of sound-containing sections in the plurality of sound waveforms, described in step S502, is executed again. Based on the identification result, of the plurality of boundaries in the plurality of specific sections, the boundaries that were automatically set using the identifier and excluding boundaries manually set by the user, are automatically updated. The user can change the specific range to include the timbre of the desired sound waveform.

In the GUI 700, if the user specifies any section with the cursor and operates a “DeNoise” button 750 (“Yes” in step S512), the system applies a denoise process to the sound waveform of the specified section (target section) and generates a new sound waveform in which the noise is suppressed (step S513). Any known method can be used for the noise removal. The user can set any of the parameters used for the denoise process. The denoised new sound waveform is used instead of the original sound waveform in the target section in the play process or the training process. If the target section is a noise-containing section, the new sound waveform in which noise is suppressed by the denoise process can be redetermined as a “specific section” by the system.

In the GUI 700, if the user specifies any section with the cursor and operates a “DeMix” button 760 (“Yes” in step S514), the system applies a sound source separation process to the sound waveform of the specified section (target section) and generates a new sound waveform in which the components other than timbres in the specific range are suppressed (step S515). Any known method can be used for the sound source separation. The user can set any of the parameters used for the sound source separation process. The new sound waveform that has been subjected to sound source separation is used instead of the original sound waveform in the target section in the play process or the training process. If the target section is an accompaniment-containing section, the new sound waveform in which other musical instrument sounds are suppressed by the sound source separation process can be redetermined as a “specific section” by the system.

In the GUI 700, if the user specifies any section with the cursor and operates a “Play” button 770 (“Yes” in step S516), the system plays the sound waveform of the specified section (target section) (step S517). For example, the user can aurally check the sounds of the sound waveforms of the target sections before and after editing (boundary editing, denoise, or sound source separation). The process of editing sections of the sound waveform described above is continued (repeating steps S509 to S518) until the user instructs to “edit another sound waveform” or “start training.”

In the GUI 700, if the user operates an “Other Waveform (Other W)” button 780 and instructs editing of another sound waveform (“edit another waveform” in step S518), the system displays the section editing GUI of FIG. 22 (step S508) for the sound waveform newly specified by the user, and performs section editing of the sound waveform (steps S509 to S518). The sound waveform is newly specified from the sound waveforms selected in step S503.

In the GUI 700, when the user operates a “Train” button 790 and instructs the start of training (“start training” in step S518), an instruction to start a training job is transmitted from the communication terminal 200 to the server 100. The system (server 100) uses, from among the selected sound waveforms, the sound waveforms of the specific sections to start the training job (step S507) for the identified acoustic model. By editing the sections, it is possible to train the acoustic model using sound waveforms of specific sections that include sections with the user's desired timbre and that excludes sections with undesired timbres.

In addition to the removal of noise and accompaniment sounds described above, reverberation sounds can also be removed. Reverberation sounds include reflected sounds, such as early reflection sounds and late reverberation sounds.

### 8. Eighth Embodiment

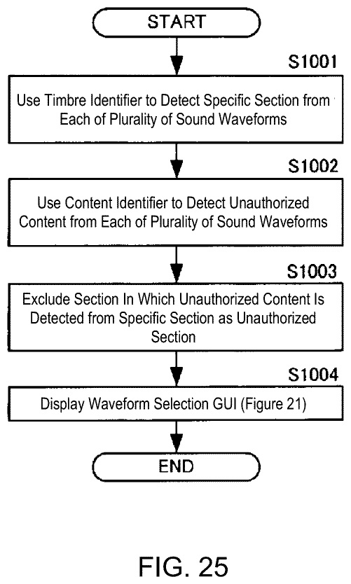

An acoustic model training system 10 according to an eighth embodiment will be described with reference to FIG. 25. The overall configuration of the acoustic model training system 10 and the block diagram relating to the server are the same as those for the acoustic model training system 10 according to the seventh embodiment, so the explanations thereof are omitted. In the following description, explanations of configurations that are the same as the seventh embodiment are omitted, and differences from the seventh embodiment will be mainly explained.

### [8-1. Training Sound Waveform Adjustment Method]

The eighth embodiment basically conforms to the flowchart of the training method shown in FIG. 20 of the seventh embodiment, but the system executes, instead of the process of step S502, a process shown in the flowchart of FIG. 25.

In this process, the system first uses a timbre identifier and a specific range in which specific sections are initially set in accordance with an acoustic model to detect, from a plurality of sound-containing sections of each sound waveform that has been prepared, sound-containing sections in which the timbre of the sound waveform is within the specific range, as specific sections (step S1001). Next, the system uses a content identifier that is set to identify unauthorized content to detect, from the plurality of sound-containing sections of each of the sound waveforms, music content for which authorization of the copyright holder has not been obtained (step S1002). The identifier identifies the musical piece and performers (not only performers of musical instruments but also singers and vocal synthesis software) of the sound waveform.

The system sets, as unauthorized sections, sections in which the sound waveform contains unauthorized content in S1002, which are excluded from the specific sections detected in S1001 (step S1003). The system displays the waveform selection GUI of FIG. 21 based on the specific sections from which the unauthorized sections have been excluded (S1004) and ends the process of FIG. 25. The system can display, in the waveform selection GUI, the inclusion of unauthorized content (“unauthorized”) in association with each sound waveform. In step S507, it is prohibited to edit the specific section to contain an unauthorized section as set herein, and even if the user performs such an editing operation, the system does not accept the editing operation.

As described above, according to the acoustic model training method of the present embodiment, for example, even if a sound waveform that a user attempts to use for training contains content of a musical piece or a performer for which authorization has not been obtained from the copyright or trademark right holder, it is possible to avoid a situation in which such unauthorized content is used for the training of an acoustic model.

### 9. Ninth Embodiment

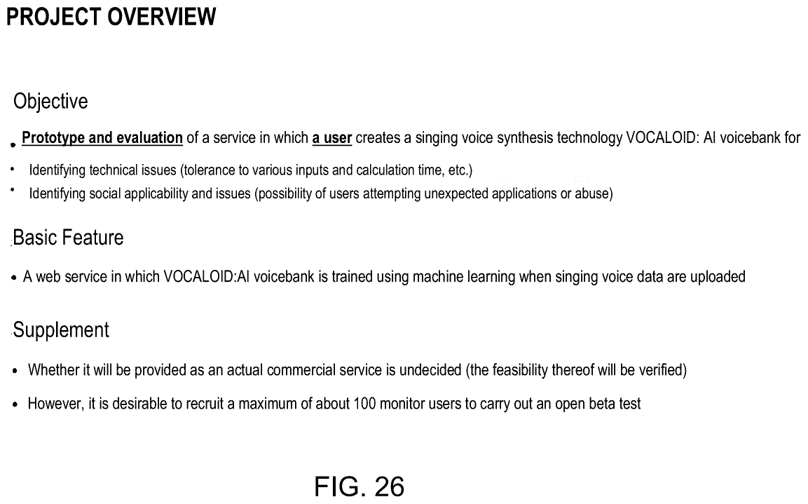

A service according to one embodiment of this disclosure will be described with reference to FIGS. 26 to 34.

FIG. 26 is a diagram explaining a project overview of a service according to one embodiment of this disclosure. FIG. 26 provides an explanation relating to a project overview. The following items are listed under “Project Overview.”
Objective
Basic Feature
Supplement

The following content is described under the item “Objective.”
Prototype and evaluation of a service in which a user creates a singing voice synthesis technology VOCALOID: AI voicebank.
Identifying technical issues (tolerance to various inputs and calculation time, etc.).
Identifying social applicability and issues (possibility of users attempting unexpected applications or abuse).

The following content is described under the item “Basic Feature.”
A web service in which VOCALOID: AI voicebank is trained using machine learning when singing voice data are uploaded.

The following content is described under the item “Supplement.”
Whether it will be provided as an actual commercial service is undecided (the feasibility thereof will be verified).
However, it is desirable to recruit a maximum of about 100 monitor users to carry out an open beta test.

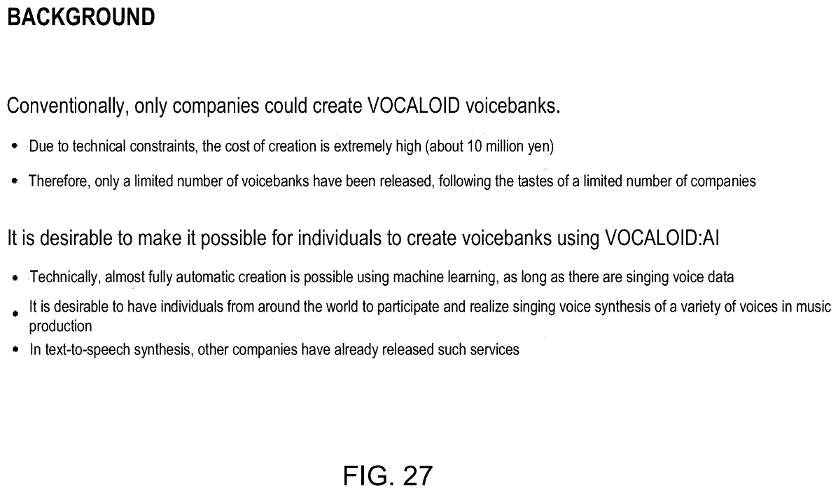

FIG. 27 is a diagram providing background information of the service according to one embodiment of this disclosure. FIG. 27 provides background information. The following items are listed under “Background.”
(A) Conventionally, only companies could create VOCALOID voicebanks.
(B) It is desirable to make it possible for individuals to create voicebanks using VOCALOID: AI.

The following content is described under (A).
Due to technical constraints, the cost of creation is extremely high (about 10 million yen).
Therefore, only a limited number of voicebanks have been released, following the tastes of a limited number of companies.

The following content is described under (B).
Technically, almost fully automatic creation is possible using machine learning, as long as there are singing voice data.
It is desirable to have individuals from around the world to participate and realize singing voice synthesis of a variety of voices in music production.
In text-to-speech synthesis, other companies have already released such services

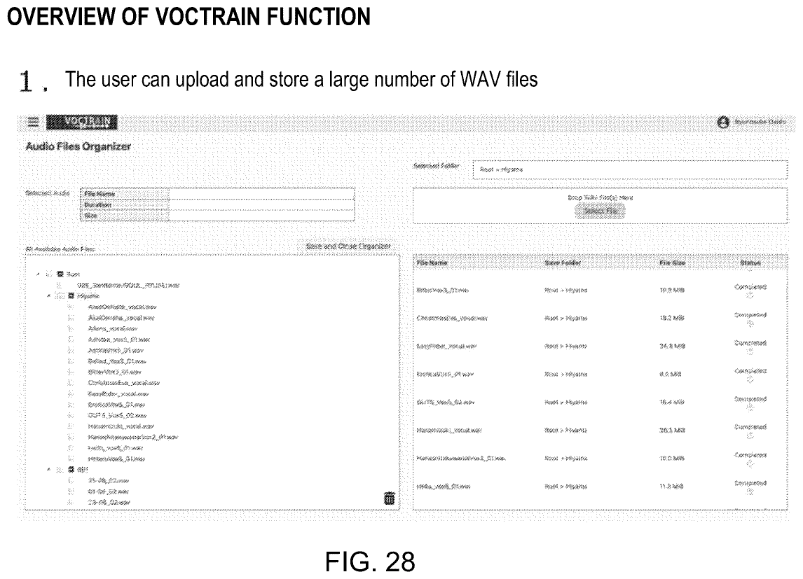

FIG. 28 is a diagram explaining an overview of functions of the service according to one embodiment of this disclosure. FIG. 28 describes an “Overview of voctrain function.” Voctrain is the name of a service according to one embodiment of this disclosure. FIG. 28 shows one example of a user interface provided in said service.

The following content is described under the “Overview of voctrain function” in FIG. 28.
1. The user can upload and store a large number of WAV files.

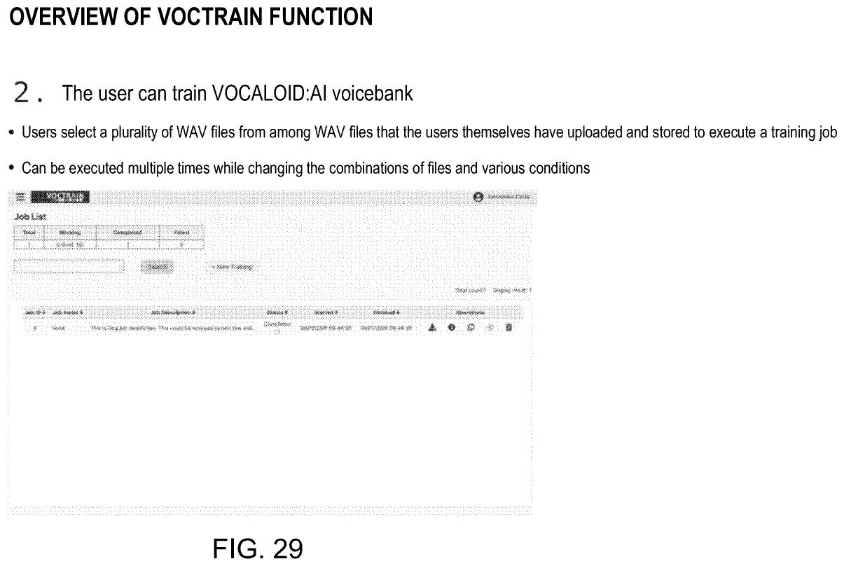

FIG. 29 is a diagram explaining an overview of functions of the service according to one embodiment of this disclosure. FIG. 29 describes an “Overview of voctrain function.” FIG. 29 shows one example of a user interface provided in said service.

The following content is described under the “Overview of voctrain function” in FIG. 29.
2. The user can train VOCALOID: AI voicebank.
   Users select a plurality of WAV files from among WAV files that the users themselves have uploaded and stored to execute a training job.
   Can be executed multiple times while changing the combinations of files and various conditions.

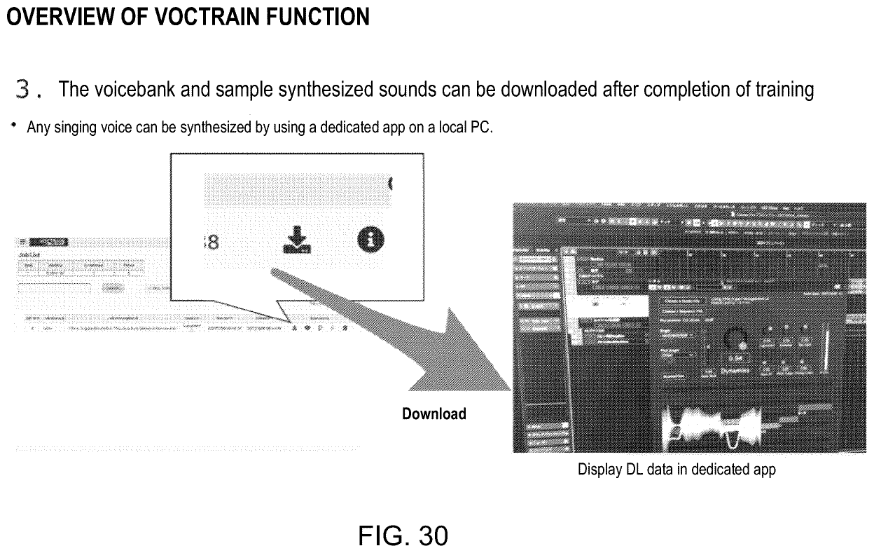

FIG. 30 is a diagram explaining an overview of functions of the service according to one embodiment of this disclosure. FIG. 30 describes an “Overview of voctrain function.” FIG. 30 shows a user interface provided in said service and an example of a sound waveform that has been downloaded to a dedicated application (dedicated app).

The following content is described under the “Overview of voctrain function” in FIG. 30.
3. The voicebank and sample synthesized sounds can be downloaded after completion of training.
   Any singing voice can be synthesized by using a dedicated app on a local PC.

As shown in FIG. 30, when a “Download” icon displayed on the user interface is selected, a sound waveform linked with the selected icon is downloaded. A screen displaying the downloaded data (DL data) in the dedicated app is shown in FIG. 30.

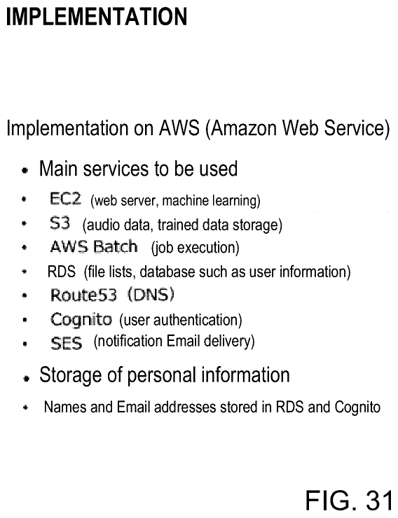

FIG. 31 is a diagram explaining implementation in the service according to one embodiment of this disclosure. FIG. 31 provides an explanation relation to implementation. The following items are listed under “Implementation.”
Implementation on AWS (Amazon Web Service).

The following items are listed under the item “Implementation on AWS.”
Main services to be used
Storage of personal information

The following items are listed under the item “Main services to be used.”
EC2 (web server, machine learning)
S3 (audio data, trained data storage)
AWS Batch (job execution)
RDS (file lists, database such as user information)
Route53 (DNS)
Cognito (user authentication)
SES (notification Email delivery)

The following content is described under the item “Storage of personal information.”
Names and Email addresses stored in RDS and Cognito

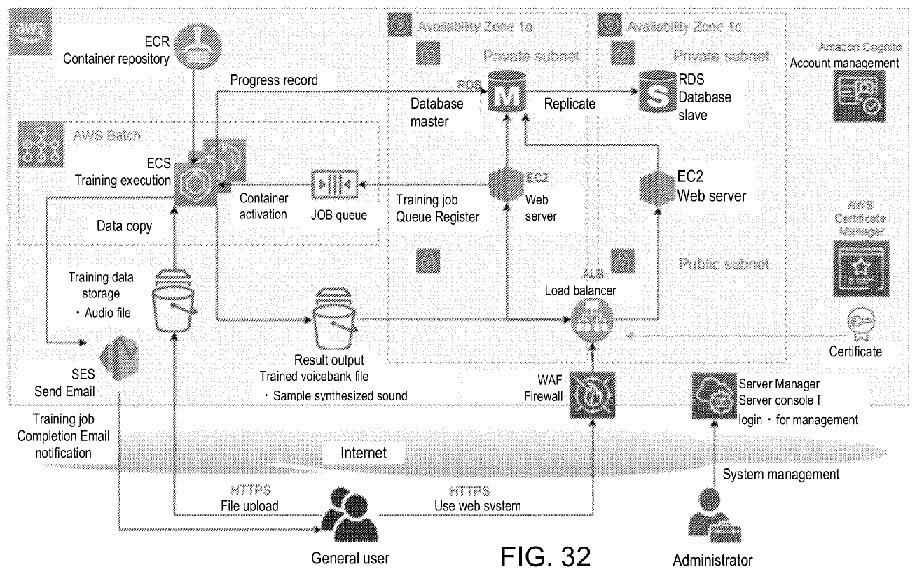

FIG. 32 is a diagram explaining a system configuration of the service according to one embodiment of this disclosure. In FIG. 32, audio files uploaded (HTTPS file upload) by general users are stored in the training data storage. Audio files stored in the training data storage are copied (data copy) to ECS (Elastic Container Service), and the acoustic model is trained in the ECS. When the training is executed, the result is output. The output result includes a trained voicebank file and sample synthesized sounds. The output result is transferred to a web server (EC2 web server) directly or via a load balancer (ALB load balancer).

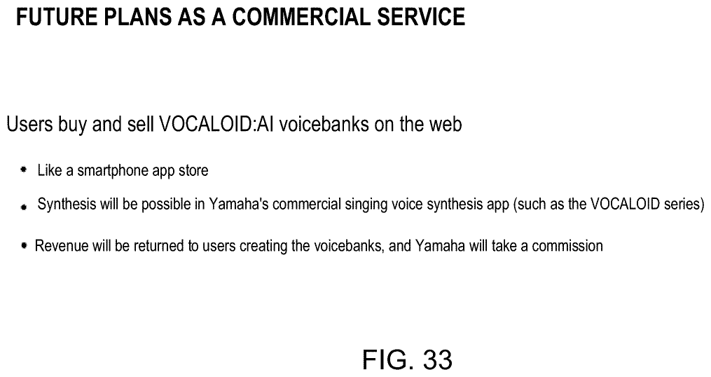

FIG. 33 is a diagram explaining future plans as a commercial service regarding the service according to one embodiment of this disclosure. FIG. 33 provides an explanation of future plans as a commercial service. The following items are listed under “Future plans as a commercial service.”

(C) Users buy and sell VOCALOID: AI voicebanks on the web

The following content is described under (C).
Like a smartphone app store.
Synthesis will be possible in Yamaha's commercial singing voice synthesis app (such as the VOCALOID series).
Revenue will be returned to users creating the voicebanks, and Yamaha will take a commission

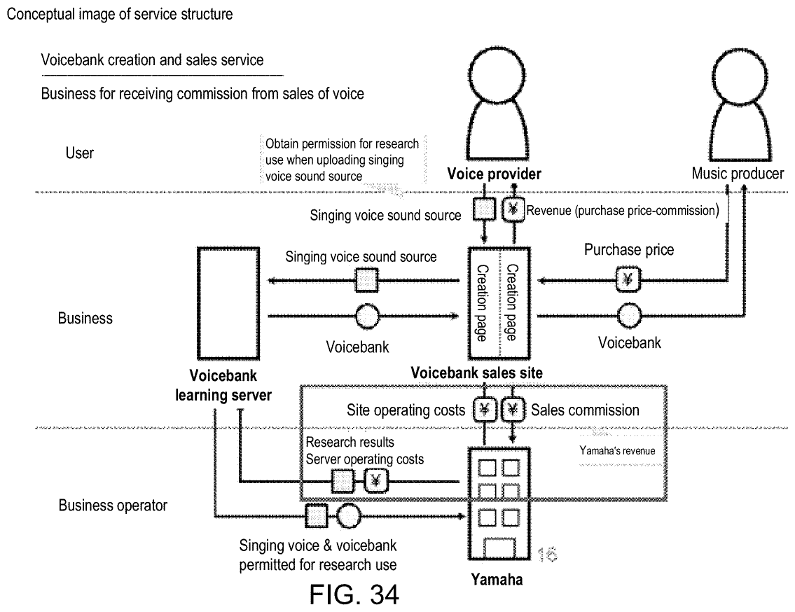

FIG. 34 is a diagram showing a conceptual image of a structure of the service according to one embodiment of this disclosure. As shown in FIG. 34, the voicebank creation and sales service is a business for receiving commission from the sales revenue of voice sales. The users are voice providers and music producers. The business will include a voicebank learning server and a voicebank sales site.

The voicebank sales site includes a creation page and a sales page. A voice provider provides (uploads) a singing voice sound source to the creation page. When uploading a singing voice sound source, the creation page asks the voice provider permission to use the singing voice sound source for the purpose of research. A voicebank is provided from the sales page to a music producer when the music producer pays the purchase price on the sales page.

The business operator bears the site operating costs of the voicebank sales site, and, in return, receives sales commission from the voicebank sales site as the business operator's proceeds. The voice provider receives, as proceeds, the amount obtained by subtracting the commission (sales commission) from the purchase price.

The singing voice sound source provided by the voice provider is provided from the creation page to a voicebank learning server. The voicebank learning server provides, to the business operator, voicebanks and singing voice sound sources for which research use has been permitted. The business operator bears the server operating costs of the voicebank learning server, and reflects the research results of the business operator on the voicebank learning server. The voicebank learning server provides, to the creation page, voicebanks obtained based on the singing voice sound sources that have been provided.

This disclosure is not limited to the embodiments described above, and can be modified within the scope of the spirit of this disclosure. For example, an embodiment according to the present embodiment can be configured as follows.

### [Disclosure 1-1]

[1. Summary of the disclosure]

In a training control method for an acoustic model,
a plurality of waveforms are uploaded from a terminal to the cloud in advance; the desired waveform is selected with the terminal from among the uploaded waveforms; in response to an instruction to initiate a training job for an acoustic model, the selected waveform is used to execute the training of the acoustic model in the cloud; and the trained acoustic model is provided to the terminal, thereby
efficiently controlling the training of the acoustic model in the cloud (server) from the terminal (device).

It is a networked machine learning system.

[2. Value of this Disclosure to the Customer]

It becomes easy to control training jobs in the cloud from a terminal.

It is possible to easily initiate and try different acoustic model training jobs while changing the combination of waveforms to be used for the training.

[3. Prior art]

Training acoustic models in the cloud
A terminal uploads a waveform for training to the cloud.
The cloud trains an acoustic model using the uploaded waveform and provides a trained acoustic model to the terminal.
The terminal must upload a waveform each time training is carried out.

### [4. Effect of the Disclosure]

It becomes easy to control training jobs in the cloud from a terminal.

### [5. Configuration of the Disclosure (Main Points, Such as Structure, Method, Steps, and Composition)]

### Definitions of Terms

One or more servers: Includes single servers and a cloud consisting of a plurality of servers.

First device, second device: Not specific devices; rather the first device is a device used by the first user, and the second device is a device used by the second user. When the first user is using their own smartphone, the smartphone is the first device, and when using a shared personal computer, the shared computer is the first device.

### [Basic System]

(1) A system for training an acoustic model that generates acoustic features comprising,
   at least a first device of a first user, and one or more servers, each connected to a network, wherein
   the first device, under control by the first user,
      uploads a plurality of waveforms to the one or more servers,
      selects one set of waveforms from the uploaded waveforms, and
      instructs the one or more servers to initiate a training job for the acoustic model, and
      the one or more servers, in response to the initiation instruction from the first device,
      executes the training job for the acoustic model using the one set of waveforms, and
      provided an acoustic model trained by the training job to the first device.

### [Disclosure to Other Users]

(2) The machine learning system of (1),
   further comprising a second device of a second user that is connected to the network, wherein
   the first device, under control by the first user,
      instructs the one or more servers to disclose the initiated training job, and
      the one or more servers, in response to the disclosure instruction,
      provides information indicating a status of the executed training job to the second device.
(3) In the machine learning system of (2),
   the status of the training job changes with the passage of time, and
   the one or more servers
      repeatedly provides information indicating the current status of the executed training job to the second device.

### [Parallel Execution of Multiple Training Jobs]

(4) In the machine learning system of (1),
the first device, under control by the first user, can select a plurality of sets of waveforms and instruct the one or more servers to initiate a corresponding plurality of training jobs in parallel, and
the one or more servers, in response to the plurality of initiation instructions, executes the plurality of training jobs using the plurality of sets of waveforms in parallel.
(5) The machine learning system of (4),
   further comprising a second device of a second user that is connected to the network, wherein
the first device, under control by the first user, selectively instructs the one or more servers to disclose a desired training job from among the plurality of the executed training jobs, and the one or more servers, in response to the disclosure instruction,
provides, to the second device, information relating to the training job for which disclosure was selectively instructed, from among the plurality of ongoing training jobs.

### [Online Billing]

(6) In the machine learning system of (1), the one or more servers, in response to the initiation instruction from the first device,
   bills the first user compensation for the execution of the training job, and execution of the training job for the acoustic model and provision of the trained acoustic model to the first device are executed when the billing is successful.

### [Karaoke Room Billing]

(7) In the machine learning system of (1),
the first device is installed in a room rented by the first user, and compensation for the execution of the training job is included in the rental fee for the room.
(8) In the machine learning system of (7),
the room is a soundproof room provided with headphones for accompaniment playback and a microphone for collecting sound.

### [Musical Piece Recommendation]

(9) In the machine learning system of (1),
the one or more servers
   analyzes a plurality of the uploaded waveforms,
   selects a musical piece suited to the first user based on the analysis result, and
   provides information indicating the selected musical piece to the first device.
(10) In the machine learning system of (9)
the analysis result indicates one or more from among performance sound range in which the first user is proficient, favorite music genre of the first user, and favorite performance style of the first user.
(11) In the machine learning system of (9),
the analysis result indicates a first user's playing skill.

### [6. Additional Explanation]

As a previous step before executing a training job using a sound waveform selected by a user from a plurality of sound waveforms, such an interface is provided to the user.

The present disclosure assumes that waveforms are uploaded, but the essence is that training is performed using a waveform selected by a user from uploaded waveforms. Therefore, it suffices that the waveforms exist somewhere in advance, which is why the expression “preregistered” is used.

In an actual service, IDs are more likely assigned on a per-user basis, rather than a per-device basis.

Since it is expected that a user will log in to the service using a plurality of devices, an entity that issues instructions and the recipient of the trained acoustic model are defined as the “first user.”

In a disclosure to other users, the progress and the degree of completion of the training are disclosed. Depending on the information that is disclosed, it is possible to check the parameters in the process of being refined by the training, and to do trial listening to sounds using the parameters at that time point.

A voicebank creator can complete training based on the disclosed information. When the cost of a training job is usage-based, the creator can execute training in consideration of the balance between the cost and the degree of completion of the training, which allows for greater degree of freedom with respect to the level of training provided to the creator.

A general user can enjoy the process of the voicebank being completed while watching the progress of the training.

The current degree of completion is displayed numerically or as a progress bar.

The present disclosure can be implemented in a karaoke room. In that case, the cost of the training job can be added to the rental fee of the karaoke room.

The karaoke room can be defined as a “rented space.” While configurations other than rooms are not specifically envisioned, the foregoing is to avoid limiting the interpretation to only “rooms.”

User accounts can be associated with room IDs.

In addition to sound waveforms, accompaniment (pitch data) and lyrics (text data) can be added to a sound waveform as added information.

The recording period can be subdivided.

The recorded sound can be checked before uploading.

When billing, the amount can be determined in accordance with the amount of CP used (complete usage-based system) or be determined based on a basic fee+usage-based system (online billing).

Sound waveforms can be recorded and updated in a karaoke room (hereinafter referred to as karaoke room billing).

The user account for the service for updating a sound waveform and carrying out a training job can be associated with the room ID of the karaoke room to identify the user account with respect to an upload ID that identifies the uploaded sound waveform.

The user account can be associated with the room ID at the time of reservation of the karaoke room.

It is made possible to specify the period for recording when using karaoke. Whether to record can be specified on a per-musical-piece basis, and prescribed periods within musical pieces can be recorded.

Before uploading, whether it is necessary to upload can be determined after doing a trial listening to the recorded data.

The music genre is determined for each musical piece. Examples of music genres include rock, reggae, and R&B.

The performance style is determined by the way of singing. The performance style can change even for the same musical piece. Examples of performance styles include singing with a smile, or singing in a dark mood. For example, vibrato refers to a “performance style that frequently uses vibrato.” The pitch, volume, timbre, and dynamic behaviors thereof change overall with the style.

The playing skill refers to singing techniques, such as kobushi.

The music genre, performance style, and playing skill can be recognized from the singing voice using AI.

It is possible to ascertain, from the uploaded sound waveforms, ranges that are lacking and sound intensity. Thus, it is possible to recommend to the user musical pieces that contain the lacking ranges and sound intensity.

### [Disclosure 1-2]

### [1. Summary of the Disclosure]

In a display method relating to an acoustic model trained to generate acoustic features corresponding to unknown input data using training data including first input data and first acoustic features, history data relating to the first input data used for the training are provided to the acoustic model, and a display corresponding to the history data is carried out before or during generation of sound using the acoustic model.

The user is able to ascertain the capability of the trained acoustic model.

The training history of the acoustic model is used.

[2. Value of this Disclosure to the Customer]

The user is able to know the strengths and weaknesses of the acoustic model based on the history data.

### [3. Prior Art]

Training of acoustic models/JP6747489
After basic training of the acoustic model, additional training can be carried out as necessary.
It is difficult for a user to determine whether a waveform to be used for basic training is sufficient.
It is difficult for a user to determine what type of waveform is best to use for additional training.

Sound generation using an acoustic model
When an acoustic model is used to process input data and generate sound, it is difficult for a user to determine whether the input data are within the trained domain or the untrained domain of the acoustic model.

### [4. Effect of the Disclosure]

The user is able to know the strengths and weaknesses of the acoustic model based on the history data.

### [5. Configuration of the Disclosure (Main Points, Such as Structure, Method, Steps, and Composition)]

(1) A method of displaying information relating to an acoustic model, realized by a computer, wherein
   the acoustic model is trained to generate acoustic features corresponding to unknown second input data using training data including first input data and first acoustic features, and is provided with history data relating to the first input data used for the training, and
   a display corresponding to the history data is carried out, in relation to sound generation using the acoustic model.

### [Displaying Learning Status of the Acoustic Model]

(2) In the display method of (1),
the display step displays the learning status of the acoustic model based on the history data, with respect to any feature indicated by the second input data.
isplays what type of input data the acoustic model has learned.
(3) In the display method of (2),
the learning status for which a distribution is displayed relates to any one of the characteristics of pitch, intensity, phoneme, duration, and style, indicated by the second input data.
   For example, ranges of pitch and intensity that have been learned are displayed.
   For example, styles that have been learned are displayed.

### [Displaying Degree of Proficiency for Each Musical Piece]

(4) In the display method of (1),
the display step estimates and displays, in relation to sound generation based on second input data generated from a certain musical piece, degree of proficiency of the acoustic model relating to the musical piece based on the second input data and the history data.
   Displays whether the acoustic model is proficient in the musical piece for which sound generation is about to be carried out.
(5) In the display method of (4),
the step for estimating and displaying comprises estimating the degree of proficiency of the acoustic model for each part of the musical piece (on the time axis), and
displaying the estimated degree of proficiency in association with each part of the musical piece.
   For example, each note of the musical piece is displayed while changing the color thereof in accordance with the degree of proficiency (proficient notes in blue, unproficient notes in red, etc.).
(6) In the display of (4),
the degree of proficiency for which a distribution is displayed relates to any one or more of the characteristics of pitch, intensity, phoneme, duration, and style, indicated by the second input data of the musical piece.

### [Displaying a Recommended Musical Piece Based on Degree of Proficiency]

(7) In the display method of (1),
the display step comprises
   estimating the degree of proficiency of each musical piece based on second input data of a plurality of musical pieces and the history data, and
   displaying, from among the plurality of musical pieces, a musical piece for which the estimated degree of proficiency is high as a recommended musical piece.

### [Displaying Degree of Proficiency in Real Time]

(8) In the display method of (1),
the display step comprises
   receiving, in real time, the second input data relating to sound generation using the acoustic model during the execution of the sound generation, and
   acquiring and displaying, in real time, the degree of proficiency of the acoustic model based on the received second input data and the history data.
[6. Additional Explanation]

For example, intensity and pitch can be set as the x and y axes, and the degree of learning at each point can be displayed using color or on an n axis.

With respect to the learning status, for example, when the second input data are data sung with a male voice, the suitability of the learning model for that case is displayed in the form of “xx %.”

The learning status indicates which range of sounds has been well learned, in a state in which the song that is desired to be sung has not yet been specified. On the other hand, the degree of proficiency is calculated after the song has been decided, in accordance with the range of sounds contained in the song and the learning status in said range of sounds. When a musical piece to be created is specified, it is determined how well the current voicebank is suited (degree of proficiency) for that musical piece. For example, it is determined whether the learning status of the intensity and range of sounds used in the musical sound is sufficient.

The determination of the degree of proficiency can be made, not only for each musical piece, but also for a certain section within a certain musical piece.

If the performance style has been learned, it is also possible to select MIDI data to recommend in accordance with the style.

A musical piece used for learning and musical pieces similar thereto are selected as recommended musical pieces. In this case, if the style has been learned, it is possible to recommend musical pieces that match the style.

### [Disclosure 1-3]

### [1. Summary of the Disclosure]

In a method for training an acoustic model using a plurality of waveforms, by acquiring a characteristic distribution of a waveform that is or was used for training and displaying the characteristic distribution that has been acquired, the user can ascertain the training status of the acoustic model.

The trend of the waveform set used for training is displayed.

[2. Value of this Disclosure to the Customer]

By identifying and preparing waveforms that are lacking in training, the user can efficiently train the acoustic model.

### [3. Prior Art]

Training of acoustic models/JP6747489.
After basic training of the acoustic model, additional training can be carried out as necessary.
It is difficult for a user to determine whether a waveform to be used for basic training is sufficient.
It is difficult for a user to determine what type of waveform is best to use for additional training.

### [4. Effect of the Disclosure]

The user can determine, by looking at the display, whether the waveform used for basic training is sufficient.

The user can determine, by looking at the display, what type of waveform is lacking.

### [5. Configuration of the Disclosure (Main Points, Such as Structure, Method, Steps, and Composition)]

[Display of training data distribution]
(1) A Method for Training an Acoustic Model Using a Plurality of Waveforms, Realized by a computer, the method comprising
   acquiring a characteristic distribution of any one of waveforms used or to be used for the training, and
   displaying the characteristic distribution that has been acquired or information relating to the characteristic distribution.

### [Effects of the Disclosure]

The user can ascertain the training status of the acoustic model.
Example: a histogram in the pitch direction or the intensity direction is displayed.
(2) In the training method of (1),
the characteristic distribution that is acquired is the distribution of one or more of the characteristics of pitch, intensity, phoneme, duration, and style.
(3) In the training method of (1),
the characteristic distribution that is acquired and displayed is a two-dimensional distribution of first and second characteristics of the plurality of waveforms.
Example, a two-dimensional histogram of pitch and intensity is displayed.
(4) In the training method of (1),
in the acquisition step, first and second characteristics of the plurality of waveforms are detected, and of the plurality of waveforms, a distribution of the second characteristic of a waveform in which the first characteristic is a prescribed value is acquired, and in the display step,
the distribution of the second characteristic that is acquired is displayed.
Example: a histogram in the pitch direction of a waveform with strong or weak intensity is displayed.
Example: a histogram in the pitch direction of a staccato waveform with a short note duration is displayed.

### [Indication of Lacking Data]

(5) The training control method of (1), further comprising detecting gaps in the acquired characteristic distribution, wherein in the display step,
information relating to the detected gaps is displayed.
(6) In the training control method of (5),
the information relating to the gap indicates a characteristic value of the gap.
The user can recognize the characteristic value of the gap and prepare a waveform to fill the gap.
(7) The training control method of (5), further comprising
a step for identifying a musical piece suitable for filling the gap, wherein the information relating to the gap indicates the identified musical piece.
The user can play and record the displayed musical piece to fill the gap.
[6. Additional Explanation]

As a specific example of a learning status (characteristic distribution), for example, with sound intensity as the horizontal axis and sound range as the vertical axis, the degree of learning of the training can be displayed in color on a two-dimensional graph. When a waveform that is planned to be used for training is selected (for example, checking a check box), the characteristic distribution of said waveform can be reviewed. With this configuration, it is possible to visually check the characteristics that are lacking in the training.

The “characteristic value of the gap” of (6) indicates which sounds are lacking in the characteristic distribution.

The “identify a musical piece” of (7) means to recommend a musical piece suitable for filling in the lacking sounds.

### [Disclosure 1-4]

### [1. Summary of the Disclosure]

In a training method for an acoustic model that generates acoustic features based on symbols (text or musical score),
a plurality of received waveforms are analyzed, sections containing sounds of the target timbre are detected, and the waveforms of the detected sections are used to train the acoustic model,
thereby establishing a higher-quality acoustic model.

Automatic selection of waveforms used for training.

[2. Value of this Disclosure to the Customer]

A higher-quality acoustic model can be established based on waveforms selected by the user.

### [3. Prior Art]

Training of acoustic models/JP6747489.
After basic training of the acoustic model, additional training can be carried out as necessary.
The quality of the acoustic model is greatly affected by the quality of the waveform used for training.
It is tedious for a user to select waveforms to be used for training.

Selection of training data/JP4829871
Automatically select training data suitable for training a voice recognition model.
This disclosure is for automatically selecting voice data for improving recognition scores of a voice recognition model, which cannot be easily applied to selecting sound data suitable for training of sound synthesis and singing voice synthesis.

### [4. Effect of the Disclosure]

A higher-quality acoustic model can be established based on waveforms selected by the user.

### [5. Configuration of the Disclosure (Main Points, Such as Structure, Method, Steps, and Composition)]

(1) A training method for an acoustic model that generates acoustic features based on a sequence of symbols (text or musical score), the method comprising
   receiving an input waveform,
   analyzing the input waveform,
   detecting a plurality of sections containing sounds of a specific timbre based on the analysis results, and
   using waveforms of the plurality of sections to train the acoustic model.

### [User Makes the Final Determination]

(2) The training method of (1), further comprising
displaying the detected plurality of sections along a time axis of the input waveform, and adjusting at least one section from among the plurality of sections in accordance with a user's operation.

Here, the training step of the acoustic model is executed using the waveforms of the plurality of sections including adjusted sections.
(3) The training method of (2), wherein
the adjustment is any of changing, deleting, and adding a boundary of the one section.
(4) The training method of (2), wherein
the waveform of the section to be adjusted is played back.

### [Removing Silence and Determining Specific Timbres]

(5) The training method of (1), wherein in the analysis step,
   presence/absence of sound is determined along a time axis of the input waveform, and
   the timbre of the waveform in the section that is determined to contain sound is determined, and in the detection step,
   the plurality of sections in which the determined timbres are the specific timbres are detected.
      [Removing Accompaniment Sounds and Noise Other than the Specific Timbres]
(6) The training method of (1), wherein in the analysis step,
   waveforms of the specific timbres are separated at least from waveforms in the sections determined to contain sound, and
   the separated waveforms of the plurality of sections are used for the training of the acoustic model.
(7) The training method of (6), wherein
in the separation step, at least one of accompaniment sounds, reverberation sounds, and noise is removed.

### [Copyright Protection of Existing Content]

(8) The training method of (1), wherein
in the analysis step, whether the input waveform has at least a partial existing content mixed therein is determined, and in the detection step, a plurality of sections containing sounds of the specific timbres are detected from sections of the input waveform that do not contain the existing content.

[6. Additional Explanation]

The present disclosure is a training method for an acoustic model that generates acoustic features for synthesizing sound waveforms when input data are provided.

The present disclosure differs from the voice recognition of JP4829871 in the point of generating acoustic features based on a sequence of symbols.

It is possible to efficiently train an acoustic model using only sections containing desired timbres (it becomes possible to train while excluding unnecessary regions, noise, etc.).

By adjusting the selected sections of a waveform, it is possible to use sections corresponding to the user's wishes to execute training of the acoustic model.

The presence/absence of sound can be determined based on a certain threshold value of the volume. For example, a “sound-containing section” can be portions where the volume level is above a certain level.

[Disclosure 1-5]

[1. Summary of the disclosure]

A method of selling acoustic models, wherein a user is supplied with a plurality of acoustic models, each with added information; the user selects any one acoustic model from the plurality of acoustic models; the user prepares a reference audio signal; under the condition that the added information of the acoustic model selected by the user indicates permission to retrain, the reference audio signal prepared by the user is used to train the acoustic model; and the trained acoustic model obtained as a result of said training is provided to the user; thereby enabling a creator to selectively supply a part of a plurality of acoustic models as a base model, and enabling the user to use the base model to easily create an acoustic model.

[2. Value of this disclosure to the customer] A creator can selectively supply a part of a created acoustic model as a base model, and a user can use the provided base model to easily create a new acoustic model.

### [3. Prior Art]

Training of acoustic models/JP6747489
After basic training of the acoustic model, additional training can be carried out as necessary.
The quality of the acoustic model is greatly affected by the quality of the waveform used for training.
It is tedious for a user to select waveforms to be used for training.

Selling user models/JP6982672
A first model published by a first party is used for retraining by a second party to generate and publish a second model.
When the second model is sold, the revenue is split between the first and second parties.
Once a model is published, the model can be freely used for retraining by a third party.

According to this disclosure, publishing is possible so as not to be used for retraining.

### [4. Effect of the Disclosure]

A creator can selectively supply a part of a created acoustic model as a base model, and a user can use the provided base model to easily create a new acoustic model.

### [5. Configuration of the Disclosure (Main Points, Such as Structure, Method, Steps, and Composition)] (1)

A method of providing an acoustic model (to a user), the method comprising (the user) obtaining a plurality of acoustic models each with corresponding added information,
(the user) preparing a reference audio signal,
(the user) selecting any one acoustic model from the plurality of acoustic models,
(in accordance with an instruction from the user) retraining the one acoustic model using at least the reference audio signal, under the condition that the added information of the one selected acoustic model can be used as a base model for retraining, and
providing (to the user) the retrained acoustic model obtained as a result of the retraining.

### [Effects of the Disclosure]

A creator can selectively supply a part of a plurality of acoustic models as a base model, and the user can use the base model to easily create an acoustic model.
(2) In the provision method of (1),
the added information includes a permission flag indicating whether the model can or cannot be used as a base model for retraining.

### [Effects of the Disclosure]

When retraining in the cloud, restricting use is simple and easy using a permission flag.
(3) In the provision method of (1),
a different training process is defined for each of the plurality of acoustic models,
the added information is procedure data indicating a training process for the one acoustic model, and
in the retraining step, the one acoustic model is retrained by carrying out a training process indicated by the procedure data.

### [Effects of the Disclosure]

It is possible to more strongly protect acoustic models for which additional training is not desired. This is because additional training cannot be carried out if the training process is unknown.
(4) In the provision method of (1),
each piece of added information indicates features of the corresponding acoustic model, and
in the selection step,
characteristics of the reference audio signal are analyzed, and the any one acoustic model is selected from among the plurality of acoustic models based on the analyzed characteristics and the features indicated by the added information of each acoustic model.

### [Effects of the Disclosure]

Additional learning can be efficiently carried out by selecting an acoustic model that matches the characteristics of the reference audio signal.
(5) In the provision method of (1),
one test musical piece is processed with each of the plurality of acoustic models to generate a plurality of audio signals of the musical piece, and
in the selection step,
   the one acoustic model is selected based on the plurality of generated audio signals.

[Effects of the Disclosure]

Any one acoustic model can be selected in accordance with the audio signal generated by each acoustic model.
(6) In the provision method of (5),
in the selection step,
   characteristics of the reference audio signal and characteristics of each of the plurality of audio signals are analyzed, and
   the any one acoustic model is selected from among the plurality of acoustic models based on the characteristics of the reference audio signal and the characteristics of each of the audio signals.

### [Effects of the Disclosure]

Even if the added information does not indicate the features of each acoustic model, additional learning can be more efficiently carried out by selecting an acoustic model that matches the characteristics of the reference audio signal.

(7) In the provision method of (1),

the plurality of acoustic models are created by one or more creators,
each creator attaches, to the acoustic model trained and created by the creator, added information indicating whether the model can or cannot be used as the base model, and sells the acoustic model (to the user), and
in the acquisition step,
the plurality of acoustic models are acquired by (the user) purchasing the plurality of acoustic models that are on sale.

### [Effects of the Disclosure]

When selling (to the user) an acoustic model created by a creator, the creator can specify whether the model can or cannot be used as a base model.

(8) The provision method of (7), further comprising

(the user) adding, to the retrained acoustic model that has been provided, added information indicating that the model can be used, or added information indicating that the model cannot be used, as the base model, and selling the model (to another user as the creator).

### [Effects of the Disclosure]

A user can sell (to another user) an acoustic model retrained by the user, while specifying (as the creator) whether the model can or cannot be used as a base model.
(9) The provision method of (7), further comprising
(the user) selling (to another user as the creator) the retrained acoustic model that has been provided.

The degree of change of the retrained acoustic model from the one acoustic model in the retraining is calculated, and
when the retrained acoustic model on sale is sold, the compensation therefor is shared (between the user and the creator of the base model) based on the calculated degree of change.

### [Effects of the Disclosure]

The user can receive compensation corresponding to the level of retraining that the user carried out.
(10) In the provision method of (7),
the added information indicating that the model can be used, which is added to the acoustic model by the creator, indicates the creator's share and further,
(the user) sells (to another user as the creator) the retrained acoustic model that has been provided.

When the retrained acoustic model on sale is sold, the compensation therefor is shared (between the user and the creator of the base model) based on the share indicated by the added information added to the one acoustic model.

### [Effects of the Disclosure]

When a user's retrained acoustic model is sold, the creator of the base model can receive a portion of the revenue.

(11) In the provision method of (1),

the plurality of acoustic models include untrained acoustic models provided with added information indicating whether the model can be used as a base model.

### [Effects of the Disclosure]

The user can train an untrained acoustic model from scratch.
(12) In the provision method of (1),
the plurality of acoustic models include, for each timbre type, a universal acoustic model that has been subjected to basic training for said timbre type, the model being provided with added information indicating whether the model can be used as a base model.

### [Effects of the Disclosure]

The user can perform retraining, starting with a universal acoustic model corresponding to a desired timbre type.

### [6. Additional Explanation]

It can be assumed that training will be performed using different acoustic models. Different acoustic models can have configurations such as different neural networks (NNs), different connections between NNs, different sizes or depths of NNs, etc. Not knowing the training process between different acoustic models means that the retraining cannot be performed.

The “procedure data” can be data indicating the process itself, or an identifier that can identify the process.

When selecting one suitable acoustic model, acoustic features can be used, the acoustic features having been generated by inputting, into the acoustic model, music data (MIDI) that are the source of the “reference audio signal,” which is a sound waveform for training.

The creator of the original acoustic model can add, to the acoustic model created by the creator, added information determining whether the model can be used as a base model.

The acoustic model can be made available for sale and purchase.

When making a creator to add first added information, an interface for adding the first added information can be provided to the creator.

A user who trains an acoustic model can add, to a trained acoustic model, added information determining whether the model can be used as a base model for training.

Compensation can be calculated based on the degree of change of the acoustic model due to training.

The creator of the original acoustic model can predetermine the creator's share.

If an identifier indicating that a model has been initialized is to be added to an “initialized acoustic model,” an indicator can be defined.

[Constituent Features that Specify the Disclosure]

The following constituent features may be set forth in the claims.

[Constituent feature 1]

A training method for providing, to a first user, an interface for selecting, from among a plurality of preregistered sound waveforms, one or more sound waveforms for executing a first training job for an acoustic model that generates acoustic features.

[Constituent feature 2]

A training method, comprising: executing a first training job on an acoustic model that generates acoustic features using one or more sound waveforms selected based on an instruction from a first user from a plurality of preregistered sound waveforms, and providing, to the first user, the acoustic model trained by the first training job.

[Constituent feature 3]

The training method according to Constituent feature 2, further comprising disclosing information indicating a status of the first training job to a second user different from the first user based on a disclosure instruction from the first user.

[Constituent feature 4]

The training method according to Constituent feature 2, further comprising: displaying information indicating a status of the first training job on a first terminal, thereby disclosing the information to the first user; and displaying the information indicating the status of the first training job on a second terminal different from the first terminal, thereby disclosing the information to the second user.

[Constituent feature 5]

The training method according to Constituent feature 3 or 4, wherein the status of the first training job changes with the passage of time, and the information indicating the status of the first training job is repeatedly provided to the second user.

[Constituent feature 6]

The training method according to Constituent feature 3 or 4, wherein the information indicating the status of the first training job includes a degree of completion of the training job.

[Constituent feature 7]

The training method according to Constituent feature 3, further comprising providing the acoustic model corresponding to a timing of the disclosure instruction to the first user based on the disclosure instruction.

[Constituent feature 8]

The training method according to Constituent feature 2, further comprising, based on an instruction from the first user,
selecting another set of sound waveforms from a plurality of uploaded sound waveforms,
initiating a second training job using the other set of sound waveforms with respect to the acoustic model, and executing the first training job and the second training job in parallel.
   [Constituent feature 9]

The training method according to Constituent feature 8, wherein information indicating the status of the first training job and information indicating the status of the second training job are selectively disclosed to a second user different from the first user, based on a disclosure instruction from the first user.

[Constituent feature 10]

The training method according to Constituent feature 2, further comprising billing the first user in accordance with an instruction from the first user, and executing the first training job when the billing is successful.

[Constituent feature 11]

The training method according to Constituent feature 2, further comprising receiving a space ID identifying a space rented by the first user, and associating an account of the first user for a service that provides the training method with the space ID.

[Constituent feature 12]

The training method according to Constituent feature 11, further comprising receiving pitch data indicating sounds constituting a song and text data indicating lyrics of the song, provided in the space, and sound data of a recording of singing during at least a portion of the period during which the song is provided, and
storing the sound data, as the uploaded sound waveforms, in association with the pitch data and the text data.
   [Constituent feature 13]

The training method according to Constituent feature 12, further comprising recording only sound data of a specified period of the provision period, based on a recording instruction from the first user.

[Constituent feature 14]

The training method according to Constituent feature 12, further comprising playing back the sound data that have been received in the space based on a playback instruction from the first user, and
inquiring the first user as to whether to register the sound data played back in accordance with the playback instruction as one of the plurality of sound waveforms that can be selected based on an instruction from the first user.
   [Constituent feature 15]

The training method according to Constituent feature 2, further comprising analyzing the uploaded sound waveform,
identifying a musical piece corresponding to the first user based on a result obtained by the analysis, and
providing information indicating the specified musical piece to the first user.
   [Constituent feature 16]

The training method according to Constituent feature 15, wherein the analysis result indicates at least one of performance sound range, music genre, and performance style.

[Constituent feature 17]

The training method according to Constituent feature 15, wherein the analysis result indicates playing skill.

[Constituent feature 18]

A method for displaying information relating to an acoustic model that generates acoustic features, the method comprising
acquiring a characteristic distribution corresponding to a plurality of sound waveforms associated with training of the acoustic model, and
displaying information relating to the characteristic distribution.
   [Constituent feature 19]

The display method according to Constituent feature 18, wherein the sound waveforms associated with the training of the acoustic model include sound waveforms that are or were used for the training.

[Constituent feature 20]

The display method according to Constituent feature 18, wherein the characteristic distribution that is acquired include the distribution of one or more of the characteristics of pitch, intensity, phoneme, duration, and style.

[Constituent feature 21]

The display method according to Constituent feature 18, wherein the characteristic distribution that is displayed is a two-dimensional distribution of a first characteristic and a second characteristic from among characteristics included in the characteristic distribution.

[Constituent feature 22]

The display method according to Constituent feature 18, wherein the acquisition of the characteristic distribution includes
extracting a first characteristic and a second characteristic from among characteristics included in the characteristic distribution, and
acquiring distribution of the second characteristic when the first characteristic is included in a prescribed range, and
the display of the characteristic distribution includes displaying the distribution of the second characteristic that has been acquired.
   [Constituent feature 23]

The display method according to Constituent feature 18, further comprising detecting a region of the acquired characteristic distribution that satisfies a prescribed condition, and
displaying the region.
   [Constituent feature 24]

The display method according to Constituent feature 23, wherein the display of the region includes displaying a feature value related to the region.

[Constituent feature 25]

The display method according to Constituent feature 23, wherein the display of the region includes displaying a musical piece corresponding to the region.

[Constituent feature 26]

The display method according to Constituent feature 18, wherein the acoustic model is a model that is trained using training data containing first input data and first acoustic features, and that generates second acoustic features when second input data are provided,
a sound waveform of history data related to the first input data is acquired as a sound waveform associated with training of the acoustic model, and the characteristic distribution corresponding to the history data is acquired, and information relating to the characteristic distribution corresponding to the history data is displayed.
   [Constituent feature 27]

The display method according to Constituent feature 26, further comprising displaying a learning status of the acoustic model for a given characteristic indicated by the second input data, based on the history data.

[Constituent feature 28]

The display method according to Constituent feature 27, wherein the given characteristic includes at least one characteristic of pitch, intensity, phoneme, duration, and style.

[Constituent feature 29]

The display method according to Constituent feature 26, further comprising evaluating a musical piece based on the history data and the second input data required for generating the musical piece, and displaying the evaluation result.

[Constituent feature 30]

The display method according to Constituent feature 29, further comprising dividing the musical piece into a plurality of sections on a time axis, and evaluating the musical piece for each of the sections and displaying the evaluation result.

[Constituent feature 31]

The display method according to Constituent feature 29, wherein the evaluation result includes at least one characteristic of pitch, intensity, phoneme, duration, and style, indicated by the second input data required for generating the musical piece.

[Constituent feature 32]

The display method according to Constituent feature 26, further comprising evaluating each of a plurality of musical pieces based on the history data and the second input data required for generating the plurality of musical pieces, and
displaying at least one musical piece from among the plurality of musical pieces based on the evaluation result.
   [Constituent feature 33]

The display method according to Constituent feature 26, further comprising receiving the second input data for a generated sound when generating the sound using the acoustic model,
evaluating the second acoustic features that have been generated based on the history data and the second input data that have been received, and
displaying the evaluation result together with the second input data.
   [Constituent feature 34]

A training method for an acoustic model that generates acoustic features based on a sequence of symbols, the method comprising detecting a specific section that satisfies a prescribed condition from among sound waveforms used for training, and
training the acoustic model based on the sound waveform included in the specific section.
   [Constituent feature 35]

A training method for an acoustic model that generates acoustic features for synthesizing sound waveforms when input data are provided, the method comprising detecting a specific section that satisfies a prescribed condition from among sound waveforms used for training, and
training the acoustic model based on the sound waveform included in the specific section.
   [Constituent feature 36]

The training method according to Constituent feature 34 or 35, further comprising detecting a plurality of the specific sections along a time axis of the sound waveform, displaying the plurality of the specific sections, and
adjusting, in the direction of the time axis, at least one section from among the plurality of the specific sections that are displayed, based on an instruction from a user.
   [Constituent feature 37]

The training method according to Constituent feature 34 or 35, further comprising detecting a plurality of the specific sections along a time axis of the sound waveform, and providing, to a user, an interface for displaying the plurality of the specific sections and for adjusting, in the direction of the time axis, at least one section from among the plurality of the specific sections that are displayed.

[Constituent feature 38]

The training method according to Constituent feature 36, wherein the adjustment is changing, deleting, or adding a boundary of the at least one section.

[Constituent feature 39]

The training method according to Constituent feature 36, further comprising playing back a sound based on the sound waveform included in the at least one section, the section being a target of the adjustment.

[Constituent feature 40]

The training method according to Constituent feature 34 or 35, wherein detecting the specific section includes
detecting a sound-containing section in the sound waveform along a time axis of the sound waveform,
detecting a first timbre of the sound waveform in the detected sound-containing section, and
detecting the specific section in which the first timbre is included in the specific timbre.
   [Constituent feature 41]

The training method according to Constituent feature 34 or 35, further comprising separating a waveform of the specific timbre from a waveform of the specific section of the sound waveform in which a sound-containing section is detected along a time axis of the sound waveform after the specific section is detected, and training the acoustic model based on the waveform of the separated specific timbre instead of the sound waveform included in the specific section.

[Constituent feature 42]

The training method according to Constituent feature 41, wherein the separation removes at least one of: a sound (accompaniment sound) played back together with the sound waveform at each time point on the time axis of the sound waveform; a sound (reverberation sound) mechanically generated based on the sound waveform; and a sound (noise) contained in a peak in the sound waveform in which the amount of change between adjacent time points is greater than or equal to a prescribed amount.

[Constituent feature 43]

The training method according to Constituent feature 34 or 35, wherein detecting the specific section includes
determining whether a prescribed content is included in at least a portion of the sound waveform that is received, and
excluding sections that do not include the prescribed content from the specific section.
   [Constituent feature 44]

A method for providing an acoustic model that generates acoustic features, the method comprising
acquiring an acoustic model associated with first added information as a target of retraining using a sound waveform,
determining whether retraining on the acoustic model can be carried out based on the first added information, and
providing a retrained acoustic model obtained by executing retraining on the acoustic model when it is determined that retraining can be carried out.
   [Constituent feature 45]

The method for providing an acoustic model according to Constituent feature 44, wherein the first added information is a flag indicating whether retraining on the acoustic model can be carried out.

[Constituent feature 46]

The method for providing an acoustic model according to Constituent feature 44, wherein the first added information includes procedure data indicating a process for retraining the acoustic model, and
the retraining of the acoustic model is carried out based on the procedure data.
   [Constituent feature 47]

The method for providing an acoustic model according to Constituent feature 44, wherein the first added information includes information indicating a first feature of the acoustic model, and
when the sound waveform used for retraining is identified, the acoustic model to be acquired as a target of retraining is selected from a plurality of acoustic models, each associated with the first added information, based on the first feature and a second feature of the sound waveform.
   [Constituent feature 48]

The method for providing an acoustic model according to Constituent feature 44, wherein the acoustic model acquired as a target for retraining is selected from a plurality of acoustic models, each associated with the first added information,
music data related to the sound waveform are used to generate a plurality of audio signals based on the plurality of acoustic features using the plurality of acoustic models, and
the acoustic model to be acquired as a target for retraining is selected based on the sound waveform and the plurality of audio signals.
   [Constituent feature 49]

The method for providing an acoustic model according to Constituent feature 44, further comprising selecting the acoustic model based on the plurality of the acoustic features and the sound waveform.

[Constituent feature 50]

The method for providing an acoustic model according to Constituent feature 44, wherein the acoustic model is an acoustic model created by one or more creators, and
the first added information is information added by the one or more creators indicating whether retraining an acoustic model created by the creators can be carried out.
   [Constituent feature 51]

The method for providing an acoustic model according to Constituent feature 44 or 50, wherein second added information is associated with the retrained acoustic model, and
the second added information is information, set by a user that executed retraining, indicating whether retraining the retrained acoustic model for which the user executed retraining can be carried out.
   [Constituent feature 52]

The method for providing an acoustic model according to Constituent feature 44 or 50, further comprising, based on a payment procedure carried out by a purchaser who purchased the retrained acoustic model,
calculating a degree of change from the acoustic model as a target of retraining to the retrained acoustic model, and
calculating compensation for the acoustic model and compensation for the retrained acoustic model based on the degree of change.
   [Constituent feature 53]

The method for providing an acoustic model according to Constituent feature 44 or 50, wherein the first added information includes share information, and
the share information is information indicating a ratio between compensation for the acoustic model as a target of retraining and compensation for the retrained acoustic model, in the compensation for the payment procedure by which a purchaser purchases the retrained acoustic model.
   [Constituent feature 54]

The method for providing an acoustic model according to Constituent feature 44, wherein there are a plurality of the acoustic models,
the plurality of the acoustic models include an initialized acoustic model, the initialized acoustic model is provided with the first added information allowing the retraining, and
the initialized acoustic model is a model in which variables are replaced by random numbers.
   [Constituent feature 55]

The method for providing an acoustic model according to Constituent feature 44, wherein there are a plurality of the acoustic models, and
the plurality of the acoustic models are associated with identifiers relating to the timbre type indicated by the acoustic features generated by the acoustic model.

### Additional Statement

An acoustic model training method realized by one or more computers according to one aspect of this disclosure comprises providing, to a first user, an interface for selecting, from a plurality of pre-stored sound waveforms, one or more sound waveforms to be used in a first training job for an acoustic model configured to generate acoustic features. In the musical piece inference device according to one aspect described above

The acoustic model training method according to one aspect of this disclosure, further comprises receiving, as a first waveform set, the one or more waveforms selected by the first user using the interface, starting execution of the first training job using the first waveform set, based on a first execution instruction from the first user via the interface, and providing an acoustic model trained by the first training job to the first user as a first acoustic model.

The acoustic model training method according to one aspect of this disclosure, further comprises providing first status information indicating a status of the first training job to a second user different from the first user, based on a first disclosure instruction from the first user.

The acoustic model training method according to one aspect of this disclosure further comprises displaying the first status information on a first device used by the first user, and displaying the first status information on a second device used by the second user based on the first disclosure instruction.

In the acoustic model training method according to one aspect of this disclosure, the status of the first training job changes with passage of time, and the acoustic model training method further comprises displaying the first status information on a second device used by the second user such that the first status information is repeatedly updated.

The acoustic model training method according to one aspect of this disclosure further comprises displaying a progress of the status of the first training job as the first status information.

The acoustic model training method according to one aspect of this disclosure further comprises displaying the first status information at a timing of a disclosure request on a second device used by the second user based on a disclosure request made by the second user.

The acoustic model training method according to one aspect of this disclosure further comprises receiving, as a second waveform set, one or more waveforms newly selected by the first user using the interface, and starting execution of a second training job using the second waveform set, based on a second execution instruction from the first user, and the first training job and the second training job are executed in parallel.

The acoustic model training method according to one aspect of this disclosure, further comprises providing at least one of first status information relating to the first training job or second status information relating to the second training job, or both, to a second device of a second user different from the first user, based on a disclosure instruction from the first user.

The acoustic model training method according to one aspect of this disclosure, further comprises billing the first user in accordance with a first execution instruction from the first user, and starting execution of the first training job upon confirmation of payment for the billing.

The acoustic model training method according to one aspect of this disclosure, further comprises receiving a space ID that specifies a real space, and linking the space ID with account information of the first user for a service that provides the acoustic model training method.

The acoustic model training method according to one aspect of this disclosure further comprises billing the first user having the account information linked to the space ID.

The acoustic model training data according to one aspect of this disclosure further comprises receiving musical score data representing sounds constituting a musical piece played in the real space, together with sound data of recording of singing or performance sounds during at least a portion of a playback period of the musical piece, and storing, as one of the plurality of pre-stored sound waveforms, the sound data linked with the musical score data.

The acoustic model training method according to one aspect of this disclosure, further comprises recording the sound data of a specified period of the playback period, based on a recording instruction from the first user.

The acoustic model training method according to one aspect of this disclosure further comprises playing back the sound data in the real space based on a playback instruction from the first user, and inquiring the first user as to whether to store the sound data played back in accordance with the playback instruction as the one of the plurality of pre-stored sound waveforms provided to the first user.

The acoustic model training method according to one aspect of this disclosure, further comprises analyzing a part of the plurality of pre-stored sound waveforms, identifying a musical piece to be recommended to the first user based on an analysis result obtained by the analyzing, and providing, to the first user, information indicating the musical piece that has identified.

In the acoustic model training method according to one aspect of this disclosure, the analysis result represents at least one or more of singing style, performance style, vocal range, or performance sound range.

In the acoustic model training method according to one aspect of this disclosure, the analysis result indicates playing skill.

A training method for an acoustic model according to another aspect of this disclosure generates acoustic features for synthesizing a synthetic sound waveform in accordance with input of features of a musical piece and is realized by one or more computers. The training method comprises detecting, from all sections of a sound waveform selected for training, along a time axis, a plurality of specific sections each of which includes timbre of the sound waveform in a specific range, and training the acoustic model, using the sound waveform for the plurality of specific sections that have been detected.

The training method according to another aspect of this disclosure further comprises displaying the plurality of specific sections, and changing at least one specific section of the plurality of specific sections in accordance with an editing operation of a user, to use, for the training, the plurality of specific sections including the at least one specific section that has been changed.

In the training method according to another aspect of this disclosure, the changing of the at least one specific section is changing, deleting, or adding a boundary of the at least one specific section.

The training method according to another aspect of this disclosure further comprises playing back sound based on the sound waveform of the at least one specific section that has been changed.

In the training method according to another aspect of this disclosure, the detecting of the plurality of specific section includes detecting, along the time axis, a sound-containing section in the sound waveform that has been selected, determining a first timbre of the sound waveform in the sound-containing section that has been detected, and detecting each of the plurality of specific sections based on whether the first timbre that has been determined is included in the specific range.

The training method according to another aspect of this disclosure, further comprises separating a component waveform of a specific timbre from the sound waveform for the plurality of specific sections after detecting the plurality of specific sections. The training of the acoustic model is executed using the component waveform that has been separated, instead of the sound waveform of the plurality of specific sections.

In the training method according to another aspect of this disclosure, the separating of the component waveform is performed by removing at least one of unnecessary component from among accompaniment sounds, reverberation sounds, and noise from the sound waveform of the plurality of specific sections.

In the training method according to another aspect of this disclosure, the detecting of the plurality of specific sections includes detecting an unauthorized section containing unauthorized content from the sound waveform that has been selected, and removing the unauthorized section from the plurality of specified sections.

Effects of this Disclosure

According to one embodiment of this disclosure, by making it possible to select data to be used for training an acoustic model from a plurality of pieces of training data, it is possible to easily execute various types of training.

According to one embodiment of this disclosure, by using in the training, from among sound waveforms used for training, only a portion(s) desired by a user, thereby efficiently training an acoustic model.

What is claimed is:

1. An acoustic model training system comprising:
a first device that is connectable to a network and that is used by a first user; and
a server that is connectable to the network,
the first device, under control by the first user, being configured to upload a plurality of sound waveforms to the server,
select, as a first waveform set, one or more sound waveforms from the plurality of sound waveforms after or before updating the plurality of sound waveforms, and
transmit, to the server, a first execution instruction for a first training job for an acoustic model configured to generate acoustic features, and
the server being configured to, based on the first execution instruction from the first device,
start execution of the first training job using the first waveform set, and provide, to the first device, a trained acoustic model trained by the first training job.

2. An acoustic model training method realized by one or more computers, the acoustic model training method comprising:
providing, to a first user, an interface for selecting, from a plurality of pre-stored sound waveforms, one or more sound waveforms to be used in a first training job for an acoustic model configured to generate acoustic features.

3. The acoustic model training method according to claim 2, further comprising receiving, as a first waveform set, the one or more waveforms selected by the first user using the interface,
starting execution of the first training job using the first waveform set, based on a first execution instruction from the first user via the interface, and
providing an acoustic model trained by the first training job to the first user as a first acoustic model.

4. The acoustic model training method according to claim 3, further comprising providing first status information indicating a status of the first training job to a second user different from the first user, based on a first disclosure instruction from the first user.

5. The acoustic model training method according to claim 3, further comprising receiving, as a second waveform set, one or more waveforms newly selected by the first user using the interface, and
starting execution of a second training job using the second waveform set, based on a second execution instruction from the first user, wherein
the first training job and the second training job are executed in parallel.

6. The acoustic model training method according to claim 5, further comprising providing at least one of first status information relating to the first training job or second status information relating to the second training job, or both, to a second device of a second user different from the first user, based on a disclosure instruction from the first user.

7. The acoustic model training method according to claim 2, further comprising billing the first user in accordance with a first execution instruction from the first user, and
starting execution of the first training job upon confirmation of payment for the billing.

8. The acoustic model training method according to claim 2, further comprising receiving a space ID that specifies a real space, and
linking the space ID with account information of the first user for a service that provides the acoustic model training method.

9. The acoustic model training method according to claim 8, further comprising
billing the first user having the account information linked to the space ID.

10. The acoustic model training data according to claim 8, further comprising
receiving musical score data representing sounds constituting a musical piece played in the real space, together with sound data of recording of singing or performance sounds during at least a portion of a playback period of the musical piece, and
storing, as one of the plurality of pre-stored sound waveforms, the sound data linked with the musical score data.

11. The acoustic model training method according to claim 10, further comprising
playing back the sound data in the real space based on a playback instruction from the first user, and
inquiring the first user as to whether to store the sound data played back in accordance with the playback instruction as the one of the plurality of pre-stored sound waveforms provided to the first user.

12. The acoustic model training method according to claim 2, further comprising
analyzing a part of the plurality of pre-stored sound waveforms,
identifying a musical piece to be recommended to the first user based on an analysis result obtained by the analyzing, and
providing, to the first user, information indicating the musical piece that has identified.

13. The acoustic model training method according to claim 12, wherein
the analysis result represents at least one or more of singing style, performance style, vocal range, or performance sound range.

14. A training method for an acoustic model that generates acoustic features for synthesizing a synthetic sound waveform in accordance with input of features of a musical piece, the training method being realized by one or more computers, the method comprising:
detecting, from all sections of a sound waveform selected for training, along a time axis, a plurality of specific sections each of which includes timbre of the sound waveform in a specific range; and
training the acoustic model, using the sound waveform for the plurality of specific sections that have been detected.

15. The training method according to claim 14, further comprising
displaying the plurality of specific sections, and
changing at least one specific section of the plurality of specific sections in accordance with an editing operation of a user, to use, for the training, the plurality of specific sections including the at least one specific section that has been changed.

16. The training method according to claim 15, wherein
the changing of the at least one specific section is changing, deleting, or adding a boundary of the at least one specific section.

17. The training method according to claim 14, wherein
the detecting of the plurality of specific section includes
detecting, along the time axis, a sound-containing section in the sound waveform that has been selected,
determining a first timbre of the sound waveform in the sound-containing section that has been detected, and
detecting each of the plurality of specific sections based on whether the first timbre that has been determined is included in the specific range.

18. The training method according to claim 14, further comprising
separating a component waveform of a specific timbre from the sound waveform for the plurality of specific sections after detecting the plurality of specific sections, wherein
the training of the acoustic model is executed using the component waveform that has been separated, instead of the sound waveform of the plurality of specific sections.

19. The training method according to claim 18, wherein
the separating of the component waveform is performed by removing at least one of unnecessary component from among accompaniment sounds, reverberation sounds, and noise from the sound waveform of the plurality of specific sections.

20. The training method according to claim 14, wherein
the detecting of the plurality of specific sections includes
detecting an unauthorized section containing unauthorized content from the sound waveform that has been selected, and
removing the unauthorized section from the plurality of specified sections.
